(19) United States
(12) Patent Application Publication
(10) Pub. No.: US 2016/0354626 A1
(43) Pub. Date: Dec. 8, 2016

(54) AUTOMATIC FIRE TARGETING AND EXTINGUISHING APPARATUS AND METHOD

(71) Applicants: Ian Edward McNamara, Elgin, IL (US); Nicholas Jospeh Toombs, Urbana, IL (US); Joshua Kim, Chicago, IL (US); Daniel Phillip McNamara, Elgin, IL (US); Nathan Lindstrom Rapp, Palatine, IL (US)

(72) Inventors: Ian Edward McNamara, Elgin, IL (US); Nicholas Jospeh Toombs, Urbana, IL (US); Joshua Kim, Chicago, IL (US); Daniel Phillip McNamara, Elgin, IL (US); Nathan Lindstrom Rapp, Palatine, IL (US)

(73) Assignee: FireStrike Industries LLC, Elgin, IL (US)

(21) Appl. No.: 15/238,701

(22) Filed: Aug. 16, 2016

Related U.S. Application Data
(63) Continuation-in-part of application No. 13/946,696, filed on Jul. 19, 2013.

(51) Int. Cl. A62C 37/40; A62C 31/02

(52) U.S. Cl. CPC A62C 37/40; A62C 31/02; A62C 99/0027

(57) ABSTRACT

A system for providing an automatic fire extinguishing system including a tank filled with an extinguishing agent with a targeting system with independently mounted targeting servos and targeting gimbal to position an emitter. A microcontroller provides control signals to the targeting servos and an actuation valve. A plurality of temperature sensors electrically connected to the microcontroller send temperature data to the microcontroller which calculates target angles and sends the target angle to the targeting gimbal. The emitter is positioned by the targeting servo positioning the targeting gimbal armatures to the target angles. The microcontroller compares sensor temperature data a predetermined temperature value and sends an open signal to the actuation valve when a sensor temperature data is greater than the predetermined temperature value. The extinguishing agent flows from the tank to the emitter, where it is discharged.

### BACKGROUND OF THE INVENTION

This application is a continuation-in-part of U.S. patent application Ser. No. 2015/0021051 filed on Jul. 19, 2013 and claims priority to this filing date.

The present invention relates to an automatic fire targeting and extinguishing system and method.

There are a myriad of fire extinguishing systems that are well known in the art. Most predominantly is the self-contained portable fire extinguisher. The portable fire extinguisher has an extinguishing agent in a sealed tank that is either pressurized or has a pressurization source connected. The user arms the portable fire extinguisher and discharges the extinguishing agent on the fire. The portable fire extinguisher has several drawbacks. First and most importantly, someone must be present at the fire location to find the fire and the portable extinguisher must be accessible to the person finding the fire. Second, the user must be in close proximity to the fire to discharge the extinguishing agent with any effectiveness, usually less than 10 feet. This can puts the user in significant danger. The larger the size and more developed the fire has become, the more dangerous the use of a portable extinguisher becomes. Further, the portable fire extinguisher has a limited capacity, usually 30-45 seconds of discharge. This limited capacity may be sufficient for small fires that are detected quickly after initiation, but has virtually no effect for more developed fires. Another drawback of the portable extinguisher is the extinguishing agent may be for a specific class of fire and not suitable for extinguishing the detected fire without increased risk to the user.

Another prior art firefighting system is a sprinkler system. Sprinkler systems have a series of sprinkler heads connected to a water main. The water main supplies a continuous application of water or other extinguishing agent to the fire. The sprinkler systems are typically actuated by the melting of a fusible link or breaking of a glass bulb at a predetermined temperature. The fusible link or glass bulb holds a plug in place against the pressure of the water main. When the fusible link melts or the glass bulb breaks, the plug is forced out of the way and the extinguishing agent is discharged in the area under the sprinkler head. In some systems, the act of discharging from one sprinkler head activates the other sprinkler heads in the building, floor, or a sector. The drawback of the sprinkler system is the continuous application of extinguishing agent such as water, does not stop until the water main is isolated from the sprinkler system. This continuous discharge can result in hundreds of gallons of water being discharged into the space. Further, in systems where the initiation of one sprinkler head activates other sprinkler heads, unaffected areas are subjected to the significant water release. The damage done to property from the discharged water can be much more than from the fire, and can include flooding of unaffected areas and the floors below.

Another prior art fire fighting system is the self-contained area sprinkler system. These systems utilize a pressured tank of extinguishing agent suspended in the overhead. The extinguishing agent is connected to a sprinkler head similar to those used in standard sprinkler systems. When the self-contained sprinkler system is activated it discharges the extinguishing agent in the area below and around the sprinkler head until the tank is exhausted. The drawback to the self-contained sprinkler system is the agent is not directed to a specific area, but is discharged over a general area limiting the effectiveness of the extinguishing agent.

Clean agent fire suppression systems are commonly used in areas with sensitive or expensive equipment. The clean agent fire suppression systems use a heavy gas such as Halon to displace oxygen, smothering the fire. The system is typically electronically activated by temperature sensors, or activated by fusible links, or manually initiated. The gas dissipates quickly after the discharge is complete and ventilation is restored, and causes no damage to the space or equipment. The drawback to these systems is the danger to personnel, because any person in the space during or immediately after the discharge will asphyxiate without breathing protection.

U.S. Pat. No. 4,671,362 to Odashima teaches an automatic fire extinguisher with infra-red ray responsive type fire detector. An embodiment of the automatic fire extinguisher includes a rotatable ejection emitter, which positions the diametric opening to the angle corresponding to a fire in a 360é range and position the emitter body to a 90é range. This embodiment requires separate servo and gearing to accommodate the positioning the diametric opening and emitter body. Further, this embodiment is limited to infra-red fire detection.

U.S. Pat. No. 3,588,893 to McCloskey teaches an apparatus for detecting and locating a fire and producing at least one information-carrying output signal. An embodiment of the apparatus has a rotatable shaft on a master synchro driven through spur reduction gears by a master servo and a slave rotor and synchro to position the emitter to the angle of the detected fire. This embodiment requires multiple gears and dependent targeting synchros to position the emitter.

U.S. Pat. No. 5,548,276 to Thomas teaches a localized automatic fire extinguishing apparatus. An embodiment of the apparatus has a motorized turret which is rotatable on averted axis by a motor terminating in a gear attached to a ring gear attached to the turret and a motorized emitter arm driven by a motor attached to a toothed wheel which engages a gear to position the arm. This embodiment requires multiple gears to position the emitter.

U.S. Pat. No. 3,752,235 to Witkowski teaches an apparatus for remotely protecting an area from a fire by dividing that area into a plurality of fire sensing devices with a fire extinguishing material dispensing device being substantially equidistant from the fire sensing devices where the fire extinguishing device directs the area protected by the fire suppression device. This embodiment is limited to only directing the suppression to specific areas covered by each fire sensing device, and as such its targeting is limited to a certain present areas determined by the placement of the fire sensing devices.

U.S. Pat. No. 6,819,237 to Wilson et al teaches an apparatus for detecting and extinguishing a spark, flame, or fire by detecting the thermal energy and converting the thermal energy to electrical energy and using the electrical energy to transmit data signals to a monitoring system. This embodiment is limited to only detecting fires on objects that have the apparatus pre-installed and would not detect a fire on any object that does not have the apparatus installed.

The prior art has failed to supply a simple fire suppression system that maximizes the effectiveness of the extinguishing agent minimizes the risk to personnel and property, and maximizes reliability.

### BRIEF SUMMARY OF THE INVENTION

One or more of the embodiments of the present invention provide an automatic fire extinguishing system including a tank filled with an extinguishing agent and a targeting system with independently mounted targeting motors and targeting armatures to position an emitter with an infra-red sensor. A microcontroller provides control signals to the targeting motors and actuation valve. Temperature and smoke sensors electrically connected to the microcontroller send data to the microcontroller which determines when to start actively scanning with the infra-red sensor. Once scanning commences, the emitter is positioned by the targeting motors. The motors position the targeting armatures so as to calculate positions to construct an infra-red image of the environment. Once an elevated heat location is located by the infra-red sensor, the microcontroller compares sensor input data to a set of predetermined criteria that represents a fire and sends an open signal to the actuation valve when the criteria is exceeded. The extinguishing agent flows from the tank to the emitter, discharging the extinguishing agent.

### BRIEF DESCRIPTION OF THE DRAWINGS

FIG. 1 is an exploded view of an extinguishing agent emission system 100 according to an embodiment of the present invention.

FIG. 2 is a schematic representation of an automatic fire targeting and extinguishing system according to an embodiment of the present invention.

FIG. 3 is an exploded view of an embodiment of the gimbal targeting system according to an embodiment of the present invention.

FIG. 4 is a block diagram of the control circuit according to an embodiment of the present invention.

FIG. 5 is a flow chart of the monitoring mode according to an embodiment of the present invention.

FIG. 6 is a flowchart of the active mode according to an embodiment of the present invention.

FIG. 7 is a flowchart of the alert routine according to an embodiment of the present invention.

FIG. 8 is a flowchart of the mode and actuation programming according to an embodiment of the present invention.

FIG. 9 is a flowchart of programming targeting values according to an embodiment of the present invention.

FIG. 10 is an overhead view of a sensor grid according to an embodiment of the present invention.

FIG. 11 illustrates the calculation of targeting angles according to an embodiment of the present invention.

FIG. 12 is an assembled view of an extinguishing agent emission system. The extinguishing agent emission system is the same as the extinguishing agent emission system of FIG. 1, but assembled for context.

FIG. 13 is an assembled view of a targeting gimbal. The targeting gimbal is the same as the targeting gimbal of FIG. 3, but assembled for context.

FIG. 14 is an exploded view of the targeting gimbal according to the present embodiment of the invention.

FIG. 15 illustrates a flow chart of the awakening criteria according to an embodiment of the present invention.

FIG. 16 illustrates a flow chart of the extinguishing routine according to an embodiment of the present invention.

### DETAILED DESCRIPTION OF THE INVENTION

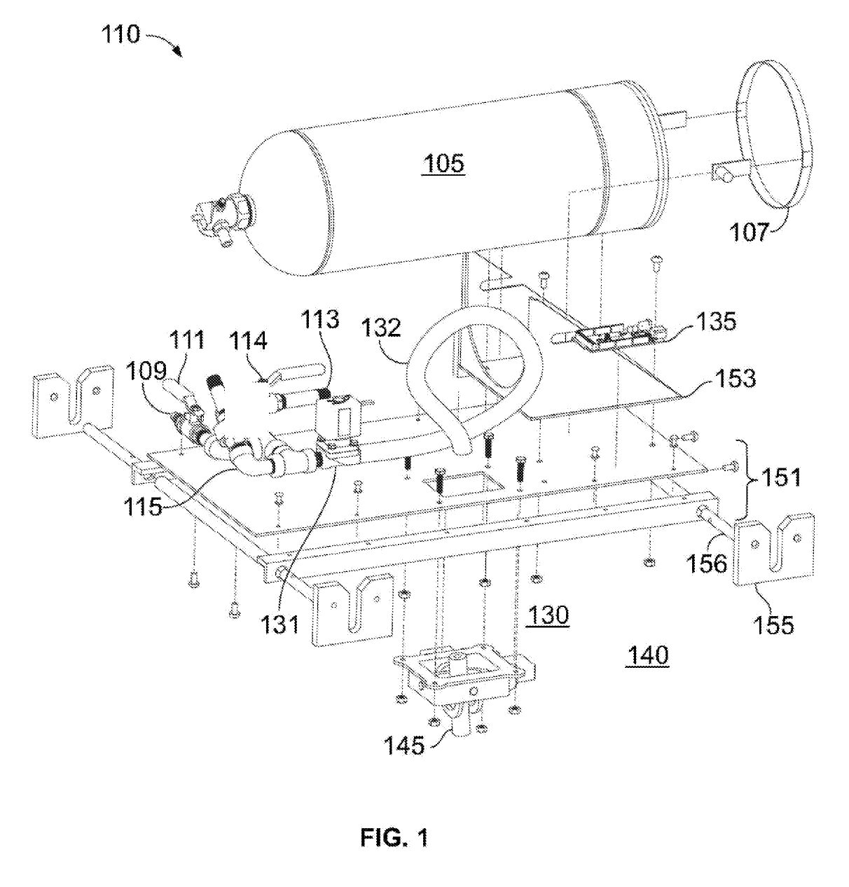

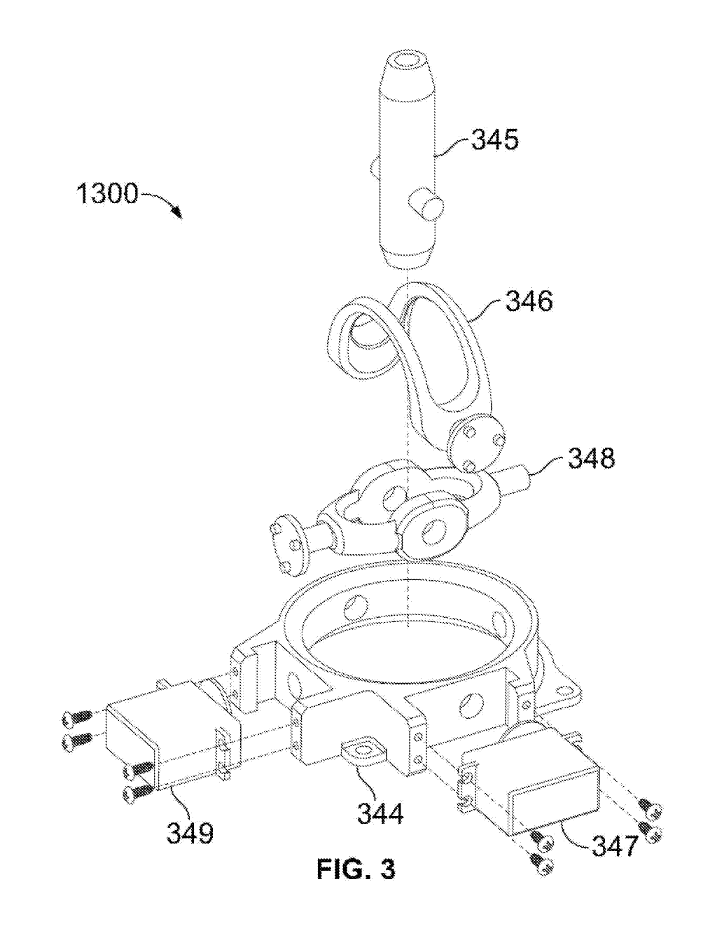

FIG. 1 illustrates an extinguishing agent emission system 100 according to an embodiment of the present invention. The extinguishing agent emission system 100 includes an agent storage system 110, an actuation system 130, a targeting system 140, and a support unit 150. The agent storage system 110 includes a pressure tank 105, a retention strap 107, a charging port 109, a charging port valve 111, a sprinkler head 113, and pressurized piping 115. The actuation system 130 includes an actuation valve 131, and flexible piping 132. The targeting system 140 includes a control circuit 135 and an emitter 145. The targeting system 140 also includes a gimbal base 344, a first targeting armature 346, a first targeting servo 347, a second targeting armature 348, and a second targeting servo 349 illustrated in FIG. 3. The support unit 150 includes a foundation 151, support pins 156, mounting brackets 155, and a tank support bracket 153.

The mounting brackets 155, of the support unit 150 are in physical connection with the structure to which the unit is to be mounted. The support pins 156 are in physical connection with the mounting brackets 155. The support pins are in physical connection with the foundation 151. The foundation is in physical connection with the tank support bracket 153. The retention strap 107 is in physical connection with the tank support bracket 153. The pressure tank 105 is in physical connection with the retention strap 107. The pressurized piping 115 is in physical connection with the foundation 151. The gimbal base 344 is in physical connection with the foundation 344. The first targeting motor 347 is physically connected to the gimbal base 344 and the first drive link 315. The second targeting motor 349 is in physical connection with the gimbal base 344 and the second drive 316. The emitter 345 is in physical connection with the targeting motors through the primary (315 and 316), secondary (320), and tertiary (325) drive links. In one embodiment, the infra-red sensor 1435 is mounted in the emitter 345. In an alternative embodiment, the first targeting servo 347 is physically connected to the gimbal base 344 and the first targeting armature. The second targeting servo 349 is in physical connection with the gimbal base 344 and the second targeting armature 348. The emitter 345 is in physical connection with the first targeting armature 346 and the second targeting armature 348.

The pressure tank 105 is in pneumatic connection with the pressure piping 115. The pressure piping 115 is in pneumatic connection with the actuation valve 131, and the charging port valve 111. The charging port valve 111 is in pneumatic connection with the pressure tank 105 and the charging port 109. The actuation valve 131 is in pneumatic connection with the flexible piping 132. The flexible piping is in pneumatic connection with the emitter 145 and the manual failsafe 113.

The control circuit 135 is in electrical connection with the actuation valve 131, first targeting servo 347 and the second targeting servo 349. In operation, the pressure tank 105 is filled with a predetermined amount of extinguishing agent. In the preferred embodiment the extinguishing agent is a standard ABC dry powder suppressant found in common residential fire extinguishers. Other acceptable agents depending on the application, include but are not limited to, water, aqueous film forming foam, carbon dioxide, and Purple K. The pressure tank 105 has an internal feeding tube which draws from the bottom of the tank or a port disposed as low as possible on the tank to utilize the maximum amount of extinguishing agent, due to the pressure tank being horizontally mounted. The pressure tank 105 is secured on to the foundation 151 by the tank support bracket 153 and retention strap 107. The pressure pi ping 115 is connected to the pressure lank 105. The pressure tank 105 is pressurized by compressed gas including, but not limited to air, nitrogen, or carbon dioxide to a predetermined value by connecting a high pressure source to the charging port 109 and opening the charging port valve 111, allowing the pressurized air to flow through the pressure piping 115 to the pressure tank. When the pressure tank 105 has reached the predetermined pressure the charging port valve 111 is shut and the high pressure source is removed from the charging port 109.

Mounting brackets 155 are placed at predetermined locations on the mounting structure. The support pins 156 are placed onto the mounting brackets supporting the weight of the extinguishing agent emission system 100. In the preferred embodiment the support pins 156 are retractable aid held in position by set screws.

In automatic operation, the control circuit 135 and sends electronic control signals to the first and second targeting servos 347, 349 as illustrated in FIG. 3. The first and second targeting servos 347, 349 position the first and second targeting armatures 346, 348 to direct the emitter 145 toward the fire. When the emitter 145 is in position the control circuit sends an electronic signal to the actuation valve 131 to open. The pressurized fire extinguishing agent flows from the pressure tank 105 through the pressure piping 115, through the actuation valve 131, through the flexible piping 132, to the emitter 145. The emitter 145 discharges the agent onto the fire until the control circuit 135 determines that the fire is extinguished or the pressure tank 105 is exhausted. When the control circuit 135 senses the fire has been extinguished, the control circuit sends an electronic signal to shut the actuation valve 131. If the fire rekindles the control circuit 135 recommences the targeting and extinguishing routine until the pressure tank is exhausted.

In backup operation, the mechanical fail-safe 113 has a glass bulb or fusible link. The fusible link or glass bulb holds a plug in place preventing discharge. The fusible link or bulb breaks or melts at a predetermine temperature. In the preferred embodiment the link melts at 145 éF, but can be made to melt at any temperature, depending on application. When the bulb or fusible links are actuated by temperature the system pressure from the pressure tank pushes the plug out. The extinguishing agent flows from the pressure tank 105 through the pressure piping 115 to the sprinkler head 113. The sprinkler head 113 discharges the extinguishing agent ewer a predetermined area until the pressure tank 105 is exhausted.

In an alternative embodiment the pressure tank 105 is a series of tanks. The pressure tanks 105 are pneumatically connected to the pressure piping 115 in parallel to increase the capacity of the system. Additionally, blow out valves and check valves are placed between the tanks to maintain pressure. As the first pressure tank 105 in the series pressure drops below a predetermined pressure the blowout valve opens to a second pressure tank. When the pressure of the first pressure tank 105 drops below a second predetermine pressure a check valve will close and seal the first pressure tank.

In an alternative embodiment, the extinguishing agent is a water supply, such as a buildings water piping. The water supply is normally under pressure and replaces the pressurized tank. The water supply is hydraulically connected to the actuation valve 131. The operation of the actuation and targeting are the same.

In an alternative embodiment, the extinguishing agent is provided by an existing fire suppression system such as a dry power fire suppression system. This outside fire suppression is normally under pressure and replaces the pressurized tank. The existing fire suppression system piping is pneumatically connected to the actuation valve 131. The operation of the actuation and targeting are the same.

In the preferred embodiment the pressure piping is cross-linked polyurethane or PEX tubing. PEX tubing is ideal for high and low temperature and pressure applications. In an alternative embodiment, the pressure piping is made of any material that is suitable for the pressure and temperatures conditions of the application, such as copper or steel.

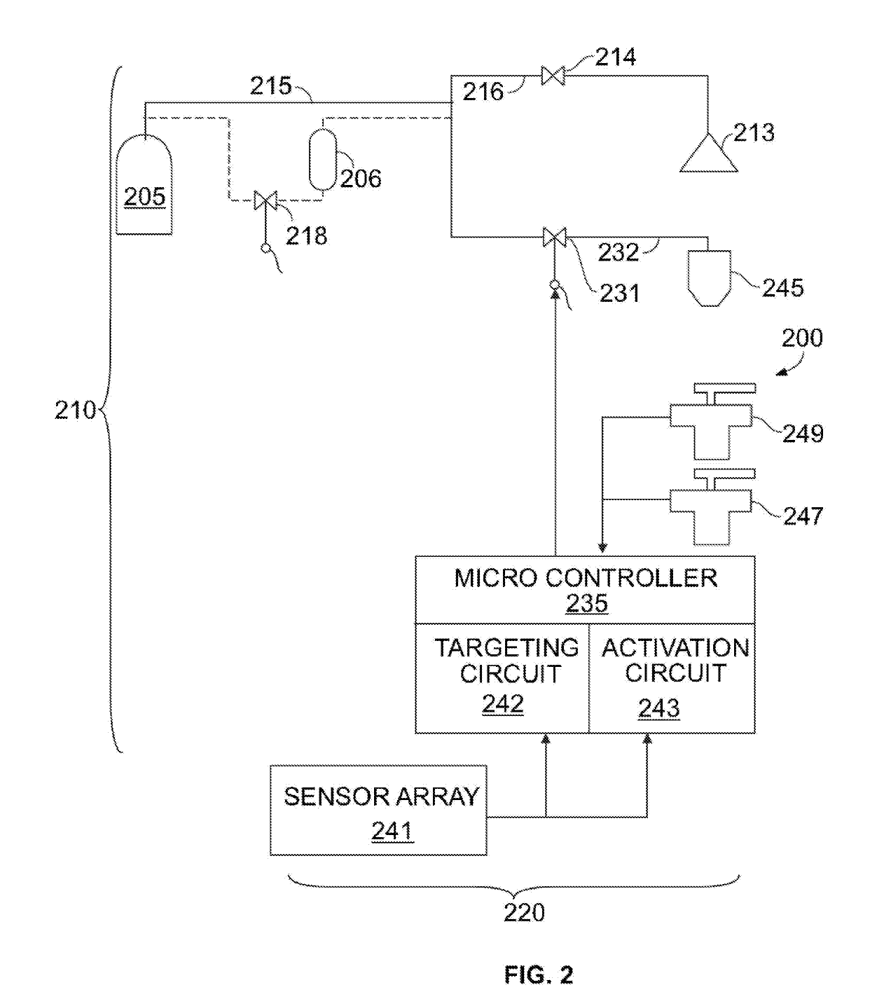

FIG. 2 illustrates a schematic representation of an automatic fire targeting and extinguishing system 200 according to an embodiment of the present invention. The automatic fire targeting and extinguishing system includes an extinguishing agent emission system 210 and a directional temperature sensor system 220. The extinguishing agent emission system includes a pressure tank 205, pressure pi ping 215, a flexible pressure tubing 216, a manual failsafe 213, an actuation valve 231, actuation circuit 243 including a microcontroller 235, a flexible tubing 232, an emitter, 245, and targeting motors 247, 249. The directional temperature sensor system 220 includes a targeting circuit 242 including the microcontroller 235, and sensors 241.

The pressure tank 205, of the extinguishing agent emission system 210, is in pneumatic connection with the pressure piping 215. The pressure piping 215 is in pneumatic connection with the manual failsafe supply piping 216, and the actuation valve 231. The manual failsafe piping 216, is in pneumatic connection with the manual failsafe 213. The actuation valve 231 is in pneumatic connection with the flexible tubing 232, of the actuation system 230. The flexible tubing 232 is in pneumatic connection with the emitter 245.

The sensors 241, directional temperature sensor system 220, is in electrical communication with the actuation circuit 242 and targeting circuit 243 of the control circuit 235. The actuation circuit 242 is in electrical communication with the actuation valve 231. The targeting circuit 243 is in electrical communication with the targeting motors 247, 249.

In one embodiment the sensor grid 241 includes nine thermistors placed in a grid pattern in the overhead of the room in the system is used in. In one embodiment, thermistors have a functional range of −40 éF to 257 éF which is desirable for an actuation setting prior to the room becoming engulfed in flames. In applications where the temperatures are higher or actuation is not desirable at an early stage of a fire such as a progressive extinguishing system, thermocouples or higher temperature thermistors may be utilized. The preferred embodiment is designed for an 8×8×8 foot room, but number of thermistors or thermistor placement can be adjusted to accommodate larger or smaller rooms. The thermistors of the sensor grid 241 send a continuous electronic signal proportional to the temperature in the monitored zone. The control circuit monitors for temperatures exceeding a predetermined value or a predetermined temperature rate increase. In the preferred embodiment the actuation temperature is 140 éF and the actuation rate is 3.6 éF over 10 seconds. The actuation temperature may be adjusted to accommodate the application. When the control circuit 235 senses an actuation value from the sensor grid 241, the targeting circuit 243, of the control circuit, sends an electronic control signal to the targeting servos 247, 249 to position the emitter 245 toward the elevated heat position. The targeting servos 247, 249 send a feedback signal to the targeting circuit to indicate the current position. When the current position of the targeting servos 247, 249 match the elevated heat or target position the targeting circuit 243 sends a signal to the actuation circuit 242. When the actuation circuit 243 receives the position match signal from the targeting circuit 243, the actuation circuit sends an open signal to the actuation valve 231. In response to the open signal the actuation valve opens. When the actuation valve 231 opens, the extinguishing agent flows from the pressure tank 205 through the pressure piping 215, through the open actuation valve 231, through the flexible tubing 232 to the emitter 245. The emitter 245 discharges the extinguishing agent onto the fire. The extinguishing agent continues to be discharged onto the fire until the pressure tank 205 is exhausted or the sensor grid 241 senses a stop condition. During extinguishing, the targeting servos 247, 249 continue to position the emitter 245 towards the current elevated heat position to as determined by the sensor grid 241. In an alternative embodiment, the emitter 245 is held in its initial fire suppression position during extinguishing.

In this embodiment when the thermistors of the sensor grid 241 senses that the temperature has decreased below a predetermined value and/or rate, the actuation circuit 232 sends a shut signal to the actuation valve 231. In response the shut signal the actuation valve shuts, stopping the flow of extinguishing agent. The control circuit 235 continues monitoring and recommences the extinguishing routine if an actuation value is again reached.

In the present embodiment, the sensor grid 241 includes an infra-red sensor attached to the emitter 345. This does not preclude the use of separate gimbals for both the extinguishing agent emitter and the infra-red camera. In the preferred embodiment, a 16 by 4 pixel array infra-red sensor with a 60é by 15é field of view is used, but this does not preclude the use of a different infra-red sensor. The infra-red sensor can have a field of view smaller than the desired coverage area as the emitter 345 can position the infra-red sensor to view any location in the coverage area. If the infra-red sensor has a field of view larger than the coverage area (if the infra-red sensor can see everywhere the emitter can direct the suppressant), the infra-red sensor can be made stationary to the system and does not have to be mounted to the emitter 345. The sensor grid 241 also includes one or more heat sensors, which can be one or more thermistors or one or more thermocouples, and a device for detecting smoke, which can be an ionization chamber or photo-electric detector or any other sensor for detecting smoke. Upon the microcontroller 435 detecting appropriate conditions based on the heat sensors) and ionization chamber, the targeting circuit 243, of the control circuit sends electronic control signals to the targeting motors 247, 249 to move the emitter 245 around the room allowing the infra red sensor to take infra-red images of the entire environment. Based on these images, the microcontroller calculates the elevated heat position and the targeting circuit 243, of the control circuit, sends electronic control signals to the targeting motors 247, 249 to move the emitter 245 to the elevated heat or target position. When the current position of the targeting motors 247, 249 match the elevated heat or target position the targeting circuit 243 sends a signal to the actuation circuit 242. When the actuation circuit 243 receives the position match signal from the targeting circuit 243, the actuation circuit sends an open signal to the actuation valve 231. In response to the open signal from the microcircuit 235 the actuation valve opens. When the actuation valve 231 opens, the extinguishing agent flows from the pressure tank 205 through the pressure piping 215, through the open actuation valve 231, through the flexible tubing 232 to the emitter 245. The emitter 245 discharges the extinguishing agent onto the fire. The extinguishing agent continues to be discharged onto the fire until the pressure tank 205 is exhausted or the microcontroller senses a stop condition. The stop condition can either be based on a maximum time and/or the appropriate conditions detected by sensor grid 241.

In backup operation, the extinguishing agent is prevented from flowing through the mechanical failsafe 213 by a plug, held in place by a fusible link or glass bulb. When the fusible link or glass bulb reach a predetermined temperature the fusible link melts or the glass bulb breaks, releasing the plug. The plug is pushed out of the mechanical failsafe by the pressure of the extinguishing agent. When the plug has been discharged the extinguishing agent flows from the pressure tank 205 through the pressure piping 215, through the mechanical failsafe supply piping 216, to the mechanical failsafe 213. The mechanical failsafe discharges and disperses the extinguishing agent into the area below until the pressure tank 205 is exhausted. This mechanical failsafe operates similar to a fire sprinkler head and in practice a standard fire sprinkler head can be used for the mechanical failsafe 213.

In an alternative embodiment, the system is designed for extinguishing agents that have adverse effects under continuous pressure, such as caking of powdered agents. In this embodiment, the system includes an extinguishing agent tank 206, a pressure tank 205 and a second actuation valve 218. The extinguishing agent tank 206 is in pneumatic connection with the first actuation valve 231 and the second actuation valve 218. The second actuation valve is in pneumatic connection with the pressure tank 205. This embodiment requires a control signal to pressurize the extinguishing agent; therefore, the backup sprinkler head 213 is removed from the system. When the control circuit 235 sends the open signal, the open signal is received by the first actuation valve 231 and the second actuation valve 210. The pressurized air flows though the pressure piping 215 through the second actuation valve 218, to the extinguishing agent tank 206, through the second actuation valve 231 and the flexible piping 232 to the emitter 245. The emitter 245 discharges the extinguishing agent onto the fire.

FIG. 3 illustrates an embodiment of the gimbal targeting system 300 according to an embodiment of the present invention. The gimbal targeting system 300 includes a gimbal base 344, an emitter 345, a first targeting armature 346, a second targeting armature 348, a first targeting servo 347, and a second targeting servo 349.

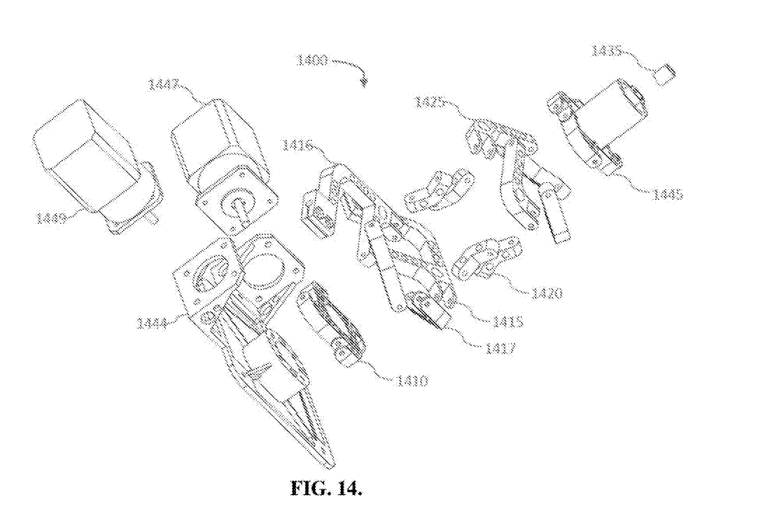

The gimbal base 344 of the gimbal targeting system is in physical connection to the foundation 151 of the support unit 150, illustrated in FIG. 1. The first targeting servo 347 is physically connected to the gimbal base 344 and the first targeting armature 346. The second targeting servo 349 is physically connected to the gimbal base 344 and the second targeting armature 348. The first targeting armature 346 is pivotally connected to the gimbal base 344 by shafts extending through the gimbal base. The second targeting armature 348 is pivotally connected to the gimbal base 344 by shafts extending through the gimbal base. The emitter is pivotally connected to the second targeting armature by a pair of pivot shafts extending from the emitter through the second targeting armature. The emitter 345 passes through the first and second targeting armatures 346, 348. Not shown in FIG. 3 is the infra-red sensor 1435, which is mounted at the end of the emitter 345. This infra-red sensor 1435 is seen in FIG. 14, an alternative embodiment of the gimbal targeting system where it is shown mounted on the end effector emitter 1445 (which takes the place of the emitter 345).

In this embodiment, in operation, the first targeting servo 347 and second targeting servo 349 may function simultaneously. When the first targeting armature receives a control signal from the targeting circuit 243, the first targeting servo 347 moves the first targeting armature 346 to the targeting position received from the targeting circuit 243. The first targeting armature 346 pivots the emitter 345 on the shafts extending into the second targeting armature 348 to place the emitter at the appropriate angle on an x-axis. When the second targeting servo 349 receives a control signal, the second targeting servo positions the second targeting armature 348 to the targeting position received from the targeting circuit 243. The emitter 345 is positioned by the second targeting armature by physical connection though the shafts extending into the second targeting armature, to an appropriate target position on a y-axis. The targeting circuit 243 monitors the position of the servos by electronic feedback signal.

FIG. 14 illustrates an embodiment of the gimbal targeting system 1400 according to the current embodiment of the present invention. This gimbal targeting system provides the same function as the alternative embodiment shown in FIG. 3. This gimbal targeting system 1400 includes a gimbal base 1444 (which takes the place of the gimbal base 344), base link 1410, a first drive link 1415, a second drive link 1416, two primary links 1417, a set of four secondary links 1420, a set of tertiary links 1425, an end effector emitter 1445 (which takes the place of the emitter 345), an infra-red sensor 1435, a first drive motor 1447 (the same as the first targeting servo 347), and a second drive motor 1449 (the same as the second targeting servo 349). In an alternative embodiment, one gimbal targeting system is used for the extinguishing agent emitter and a separate gimbal targeting system is used for the infra-red sensor. Each gimbal could be of the form shown in FIG. 14. In embodiments of the invention that either do not use an infra-red sensor, or where the field of view of the infra-red sensor is at least as large as the coverage area, the infra-red sensor 1435 is omitted from the gimbal targeting system.

The gimbal base 1444 is the physical connection to the foundation 151 of the support unit 150 illustrated in FIG. 1. The first drive motor 1447 is physically coupled to the gimbal base 1444 and to the first drive link 1415. The second drive motor 1449 is physically coupled to the gimbal base 1444 and to the second drive link 1416. The two drive links 1415 and 1416 and the two primary links 1417 are pivotally connected to the base link 1410 which is fixed to the gimbal base 1444. The two drive links 1415 and 1416 and the two primary links 1417 are also pivotally connected to the four secondary links 1420. The four secondary links are pivotally connected the fair tertiary links 1425. The four tertiary links 1425 are pivotally connected to the end effector emitter 1449. The infra-red sensor 1435 is fixed to the end effector emitter 1445. Not shown in in FIG. 14 is a flexible tube that passes through the gimbal base 1444 and base link 1410 and is attached to the emitter 1445. This flexible tube is seen in FIG. 1 as flexible piping 132. This flexible tube 132 provides passage for the suppressant allowing the suppressant to be directed by the gimbal and flow out of the emitter 1445.

In operation the first drive motor 1447 and second drive motor 1449 may function simultaneously. When a control signal is sent to the first drive motor 1447, the first drive motor 1447 rotates the first drive link 1415 which resets in a rotation of the end effector emitter 1445 around the axis of the first drive motor 1447. When a control signal is sent to the second drive motor 1449, the second drive motor 1449 rotates the second drive link 1416 which results in a rotation of the end effector emitter 1445 around the axis of the second drive motor 1449. When a control signal is sent to both the first drive motor 1447, and the second drive motor 1449 simultaneously, the two drive links 1415, and 1416 both rotate simultaneously which results in a mixing of rotations of the end effector emitter 1445 about both the first drive motor 1447 axis and the second drive motor 1449 axis.

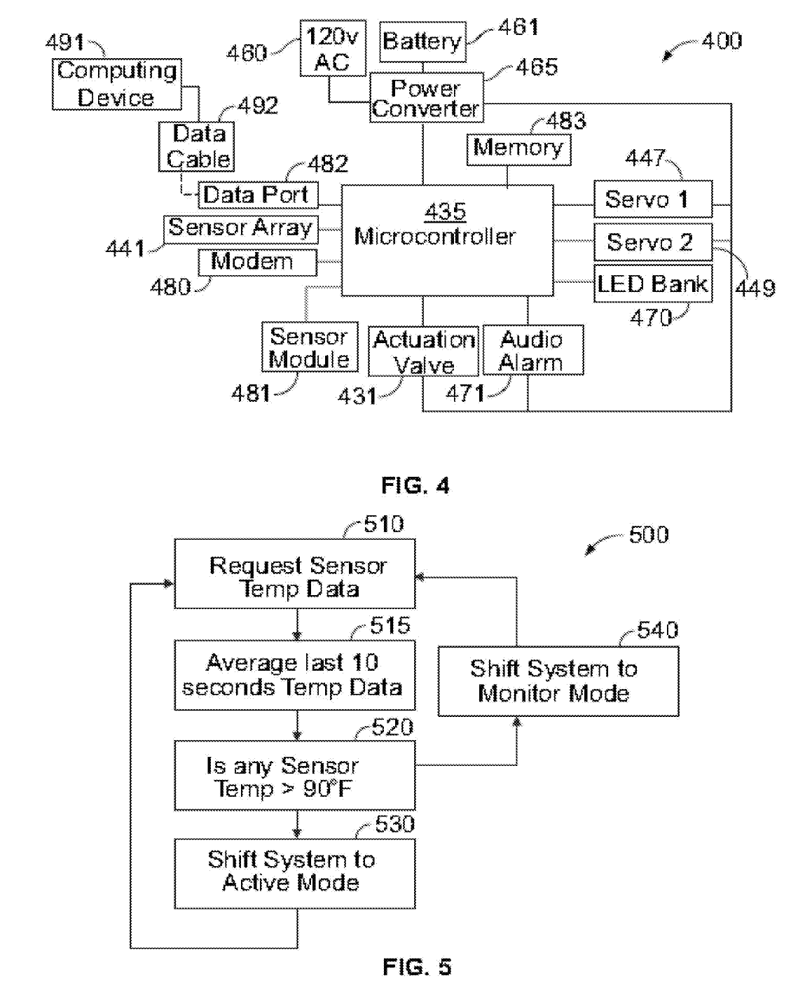

FIG. 4 illustrates a block diagram of the control circuit 400 according to an embodiment of the present invention. The control circuit 400 includes a microcontroller 435, a first targeting motor 447, a second targeting motor 449, an actuation valve 431, a sensor grid 441, a 120v AC power source 460, a battery 461, a power converter 465, an LED bank 470, an audio alarm 471, a modem 480, a cellular module 481, a data port 482, a memory 483, a computing device 491, and a data cable 492.

The microcontroller 435 is in electronic communication with the first targeting motor 447, the second targeting motor 449, the LED bank 470, the actuation valve 431, the sensors 441, the audio alarm 471, the modem 480, the cellular module 481, the data port 482, and the memory 483. The power converter 465 is in electrical connection with the 120v AC power source 460, the battery 461, the microcontroller 435, the first targeting motor 447, the second targeting motor 449, the LED bank 470, the audio al arm 471, and the actuation valve 431. The computing device 491 is in electrical communication with the data cable 492. The data cable 492 is in electrical communication with the data port 482.

In operation, the computing device 491 is electrically connected to the data port 482, of the microcontroller 435, using the data cable 492. The computing device 491 is used to enter values into the main operating loop and upload the main operating loop to the microcontroller 435. The microcontroller 435 stores the main operating loop in the internal memory. After the computing device 491 has completed uploading the main operating loop to the microcontroller 435, the computing device and the data cable are disconnected from the data port 482.

The 120v AC power source 460 provides 120v AC power to the power converter 465. The power converter 465 converts the 120v AC power to DC power at the necessary voltages. The power converter 465 supplies DC power to charge the battery 461, in normal operation, and to the microcontroller 435, audio alarm 471, and actuation valve 431. The power converter also supplies DC power to the targeting motors 447, 449. If power is interrupted from the 120v AC power source 460, the battery 461 supplies power through the power converter 465. In an alternative embodiment, the system is powered off DC power directly. In this embodiment power converter 465 would simply convert the incoming DC power to the necessary voltages.

The microcontroller 435 sends signals to the LED bank 470 to indicate system status. The LED bank 470 has a plurality of LEDs indicating a function or status of the system. In one embodiment when the control circuit 135 is energized the microcontroller 435 sends a signal to energize a ‘system power_LED in the LED bank 470. When the microcontroller 435 sends an open ‘actuation_signal to the actuation valve 431, the microcontroller sends a signal to deenergize a ‘ready_LED, and sends a signal to energize an ‘alert_LED in the LED bank 470. Depending on the functions equipped and the requirements for monitoring LEDs are added or removed to the LED bank 470 and the microcontroller programmed to illuminate as necessary.

In the various embodiments of the present invention, targeting does not occur until the appropriate conditions are detected by the sensor grid 441. During this time, referred to as monitor mode, the system samples the sensor grid 441 and regular intervals and continues to check if the appropriate conditions are met. Once the appropriate conditions are detected, the system engages in targeting; referred to as targeting or active mode.

In one embodiment, when the system is in monitor mode the motors are kept at home position, or middle of the gimbal armature rotation travel, with the emitter 145 pointed straight down so as to minimize the time required to position the emitter 145 to any area in the coverage area. In the preferred embodiment, no targeting signals are sent from the microcontroller 435 to the targeting motors 447, 448 to conserve power. In alternative embodiments targeting signals are applied to maintain the emitter 145 pointed down. In another embodiment, the microcontroller turns off the targeting motors 447, 448 until the microcontroller shifts to active mode. The microcontroller 435 shifts to active mode when detecting the appropriate conditions from the sensor group 441.

In one embodiment, when the system shifts from monitor mode to active mode upon detecting the appropriate conditions from the sensor group 441, the microcontroller retrieves the alert data from the memory unit 483. The microcontroller sends the phone number portion of the alert data to the modem 480 or cellular module 481. When the modem 480 or cellular module 481 establishes a connection with a receiver through the phone line, the modem sends a communication established signal to the microcontroller 435. In response to the communication established signal, the microcontroller 435 sends a warning message to the modem 480 or cellular module 481. The modem 480 or cellular module 481 transmits the warning message to the receiver through the phone line to the receiving party. If the alert data includes multiple numbers, such as emergency service and owner, the microcontroller will execute the alert transmissions in the order that the numbers are programmed, until all warning messages have been delivered.

In the current embodiment of the present invention, the system is equipped with warning lights and/or speakers. Upon the system shifting from monitor mode to active mode; the warning lights and/or speakers provide a visual and/or audio warning to any nearby individuals. In an alternative embodiment no warning lights or speakers are utilized.

In one embodiment of the present invention, targeting the fire is accomplished by a plurality of heat sensors in a grid like pattern. Additional sensors including but not limited to smoke detectors(s), photo-electrical sensors, and infra-red sensors or cameras can be used to help targeting. This embodiment of the invention is described in sections [0065] through [00105].

The microcontroller 435 requests information from the sensor grid 441 at an interval of 0.5 seconds. The sensor grid 441 includes a plurality of thermistor, whose resistance is representative of the temperature in the monitored area. The microcontroller 435 receives the resistance value from the sensor grid 441 and converts the voltage to a temperature value. When the microcontroller 435 senses the appropriate conditions from the sensors 441, the microcontroller commences targeting. When the microcontroller 435 senses a temperature above the predetermined actuation value or a predetermined temperature rate, calculated on a 10 second rolling average period, the microcontroller commences an extinguishing routine. In alternative embodiments the temperature rate calculation can be set to a higher or lower value, such as 0, 5, 20 or 60 seconds, depending on the size and environment of the room to be monitored.

In an alternative embodiment the main operating loop, beginning with the request of information from the sensor grid 441 is 0.5 seconds. In alternatives embodiments the main operating loop time is set to meet the specific conditions of the monitored area, such as 0.1, 0.25, 0.5, or 1 seconds.

The microcontroller 435 is programmed with the grid position of each sensor, in the sensor grid 441. The microcontroller weights the temperatures of the sensors giving priority to sensors with the highest temperature above a reference value. The microcontroller 435 uses the weighted percent per sensor to determine the elevated heat position and corresponding targeting angles, by multiplying the weighted percent of the thermistor to the known sensor positions. The microcontroller 435 determines a final targeting angle on an x and y axis centered on the extinguishing system, representing the location of the fire, or elevated heat position. Each target angle is sent to the targeting portion of the microcontroller 435. The microcontroller 435 determines a control signal to a desired armature position corresponding to the targeting angle, and sends the control signal or target angle data to the targeting servos 447, 449. The targeting servos 446, 448 move the targeting armatures 346, 348 to the received target angle data, positioning the emitter 345 to the elevated heat position. The microcontroller 435 receives actual armature position from the targeting servos 447 449 by sampling a feedback loop.

When the microcontroller 435 receives position angles equal to the targeting angles from the feedback loop of targeting servos 447, 449, and the microcontroller receives the appropriate conditions from the sensor group 441, the microcontroller sends an open signal to the actuation portion of the microcontroller 435. The microcontroller 435 sends an open signal to the actuation valve 431 to open to emit extinguishing agent.

To prevent continuous targeting and hunting, the microcontroller 435 is programmed with an activation value and dead zone. When the microcontroller 435 determines that no thermistor exceeds a predetermined activation value, such as 90éF, no commands or signals to maintain position are sent from the microcontroller to the targeting servos 447, 449. When the microcontroller 435 is in active mode, the microcontroller will calculate the targeting angles each 0.5 second loop. If either targeting angle changes by greater or equal to 5%, the microcontroller 435 will send updated targeting angles to the targeting servos 447, 449, without disrupting the open signal to the actuation valve 431.

In one embodiment, this targeting dead zone of 5% is changed in the first and/or second targeting angle. In rooms with smaller or larger dimensions the dead band is set to lower or higher values such as, 1 or 10% to increase target vector accuracy.

In an alternative embodiment, the sensor grid 441 is equipped with thermocouples for higher temperature application or actuation points. The thermocouples operate in the same way as the thermistors, but have a reliable temperature range higher than a thermistor.

In an alternative embodiment, the sensor grid 441 is equipped with photo-electric sensors. The photo-electric sensors detect light from a fire, in an unlit room or from a bright fire in a lit room. The microcontroller 435 will sample the photo-electric sensors at the same 0.5 second interval. During an extinguishing routine if the microcontroller 435 determines that greater than a predetermined number of photo-electric sensors do not detect light above a predetermine level; the photo-electric sensors will be included in the weighted target angle calculation. After the initial actuation of the system, the microcontroller 435 removes the photo-electric sensor data from the target vector angle calculation due to smoke inhibiting the reliability of the sensor. If during an extinguishing routine, the microcontroller 435 determines that greater than a predetermined number of the photo-electric sensors detect light, the photo-electric sensor data is not used for calculation, assuming that the room is lit and therefore light data is not reliable for locating the fire. In an alternative embodiment, the photo-electric sensor data continues to be used with a threshold limit such as 10% higher than other sensors.

In an alternative embodiment, the sensor grid 441 is equipped with ionization chamber or chambers. The ionization chamber of the sensor grid 441, detects the presence of smoke in the monitored space. The microcontroller 435 samples the ionization chamber at the same 0.5 second interval. If the microcontroller 435 determines that the ionization chamber detects the presence of smoke, the microcontroller lowers the actuation temperature value and rate. The lower actuation temperature value and rate allow for extinguishing routine tote performed sooner without increasing the risk of inadvertent discharge. If the sensor grid 441 is equipped with multiple ionization chambers, the target angle calculation is modified to incorporate the smoke data. The microcontroller 435 assigns a higher weight to areas with smoke, until a predetermined number of ionization chambers detect smoke. When the predetermined number of ionization chambers detect smoke the data from the ionization chamber will be renewed from the calculation, because it no longer be strongly correlated with the fire location.

In an alternative embodiment, the sensor grid 441 includes an infra-red or thermal imaging camera. The infra-red camera sends higher accuracy temperature data to the microcontroller 435. The inferred camera is calibrated with the targeting circuit 243 to provide accurate targeting angels from a single camera or cross checked targeting angles from multiple cameras. If multiple infra-red cameras are equipped the microprocessor 435 will equally weight the target location data of each camera that has detected an actuation temperature or rate.

In an alternative embodiment, the sensor grid 441 includes digital temperature detectors. The digital temperature detectors operate in the same way as the thermistors but would send a digital signal to the microcontroller 435, eliminating the need to convert the analog voltage supplied by a thermistor to a digital signal.

FIG. 5 illustrates a flow chart of the monitoring routine 500 according to an embodiment of the present invention.

First, at step 510 sensor temperature data is requested by the microcontroller. The microcontroller 435 requests temperature data form each of the sensors in the sensor grid 441. Next at step 515, the microcontroller 435 averages the last 10 seconds of temperature data of each sensor in response to receiving the temperature data from the sensor grid 441. The microcontroller 435 writes the temperature data to memory and deletes the oldest reading. The averaging of the last 10 seconds of temperature data 515 prevents microcontroller actions based on electrical noise. The temperature data averaging time, is 10 seconds in the preferred embodiment but is changed to a higher or lower valve, such as 0, 1, 5, 20, or 60 seconds depending on the detectors used and the environment, to account for the relative noise detected by the sensors. Next at step 520, the microcontroller 435 compares the average sensor temperature to a predetermined value. The predetermined value is set high enough to prevent the system from entering active mode when no fire conditions exist. This prevents wear on the system components and conserves energy, preventing continuous targeting and hunting. In the preferred embodiment, the predetermine value is 90 éF. The predetermined value is set to a higher or lower value to accommodate the environment of the space to be monitored for example 85, 100, 110, or 200 éF. If the temperature data for one or more sensors is greater than the predetermined value, the microcontroller 435 shifts to active mode 530. If the temperature data from all sensors is less than the predefined value the system shifts to monitor mode 510. The system completes this check every program cycle, after the system shifts to active mode 530 or shifts to monitor mode 540 the microcontroller 435 will recommence the process by requesting sensor temperature data at step 510.

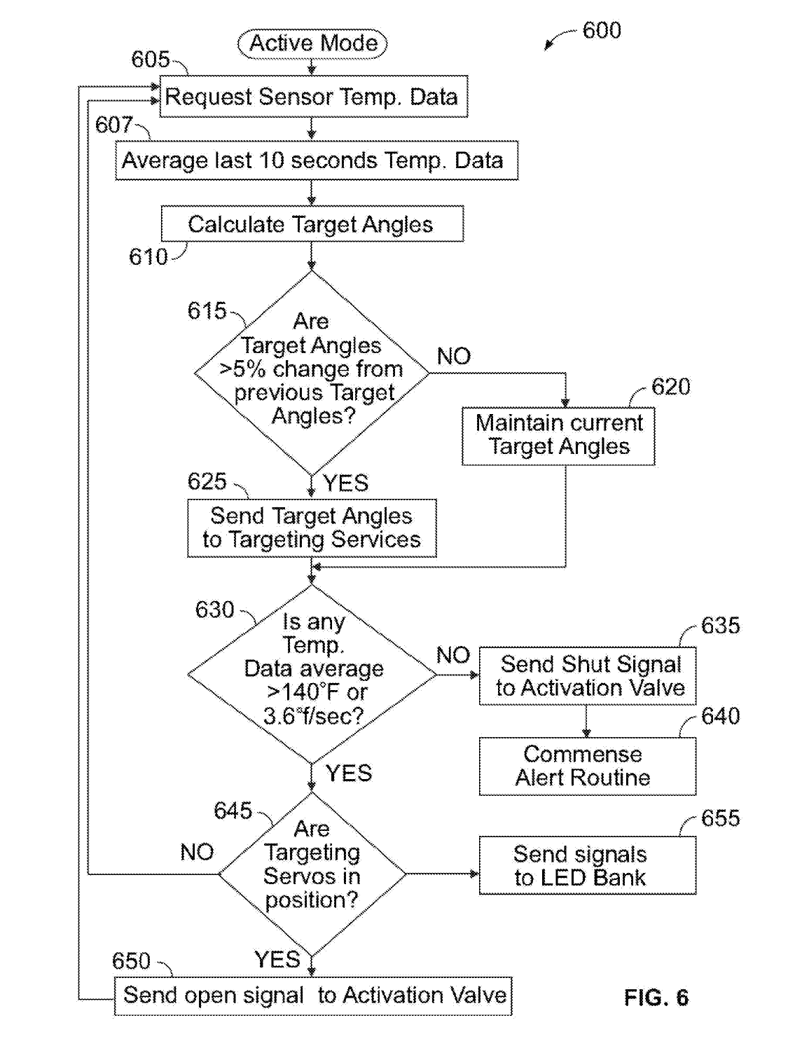

FIG. 6 illustrates a flowchart of the active mode 600 according to an embodiment of the present invention.

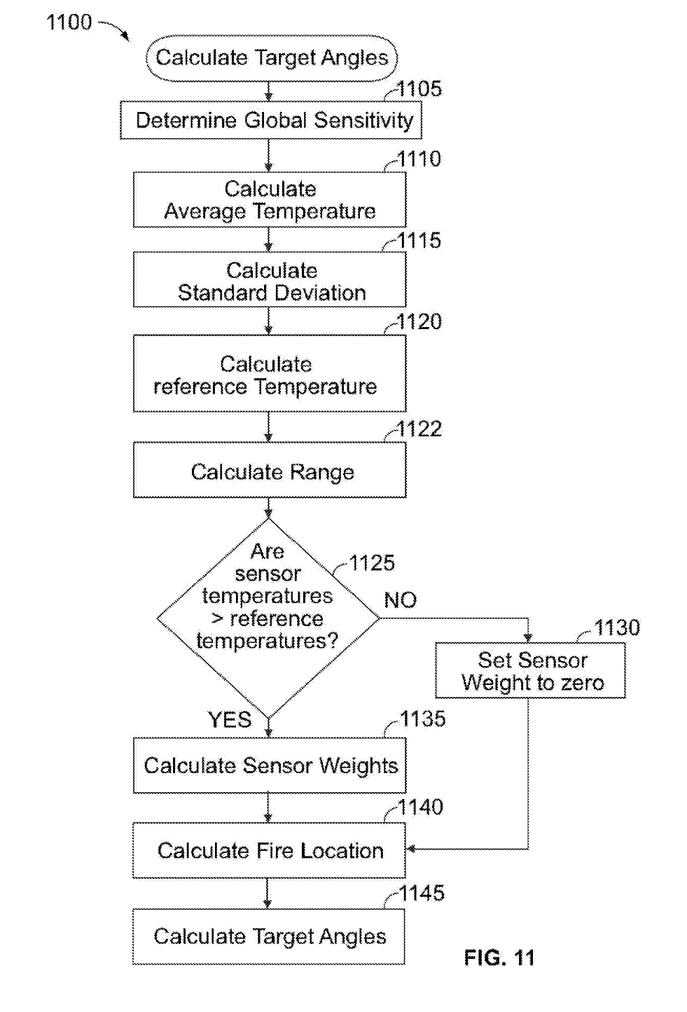

First at step 605, the microcontroller 435 requests sensor temperature data 605, from each sensor in the sensor grid 441. Next at step 607 the microcontroller 435 averages the last 10 seconds of temperature data for each sensor, in response to receiving the sensor temperature data, the microcontroller retrieves the last 9 seconds of temperature data stored in memory. Next at step 610, the microcontroller 435 calculates targeting angles. The elevated heat position is determined by weighting the known location of the temperature sensors in the grid by the temperature data, then converting the elevated heat position to targeting angles on an x and y axis, illustrated in FIG. 11. Next in step 615, the microcontroller 435 performs a comparison of the current target angle to the previous target angle. If either targeting angle is greater than a predetermine percent difference, such as 5%, from the previous targeting angle, the microcontroller 435 performs step 625, send the targeting angle data to the targeting servos 447, 449. If the current targeting angles are less than the predetermined percent difference from the previous targeting angle, the microcontroller 435 performs step 620, send the previous targeting angle data to the targeting servos 447, 449. After step 625, sending the targeting angle data or step 620, maintaining the targeting angle data, in step 630, the microcontroller 435 performs a comparison of the average sensor temperature data to the predetermined temperature value and rate value. The microcontroller 435 will compare each of the average sensor temperature to the predetermined actuation value and temperature change rate value. If no sensor temperature exceeds the predetermined actuation value or rate value, the microcontroller 435 performs step 635, send a shut signal to the actuation valve. Next, the microcontroller 435 recommences the process at step 605 by requesting sensor temperature data.

If any of the sensor temperatures exceed the predetermine temperature value or rate value, the microcontroller 435 commences the alert routine 640, and performs step 645, a comparison of the targeting angles to the targeting servo positions 645. If the targeting angles and targeting servo positions do not match, the microcontroller recommences the process at step 605 by requesting sensor temperature data. This allows for an additional operating loop to be performed while the servos reposition. When the microcontroller 435 determines that the targeting angle data and the targeting servo positions match, the microcontroller performs step 650, sending an open signal to the actuation valve. In addition to sending the open signal to the actuation valve, the microcontroller performs step 655 sends signals to update the LED bank. The LED for ‘ready_is deenergized and the LED for ‘alert_is energized. After performing step 650, sending the open signal to the actuation valve, the microcontroller 435 recommences the process at step 605 by requesting sensor temperature data.

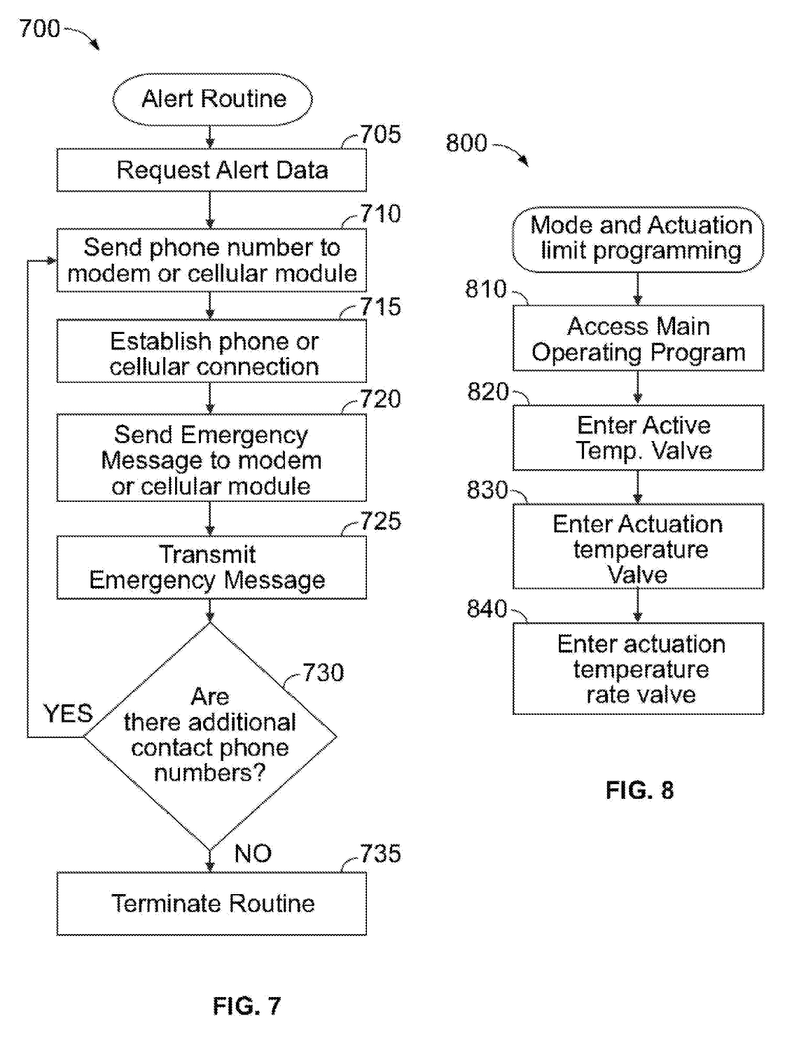

FIG. 7 illustrates a flow chart of the alert routine 700 according to an embodiment of the present invention.

First at step 705, the microcontroller 435 requests alert data from the memory unit 483. Next at step 710, the microcontroller 435 sends the first emergency phone number to the modem 480 or the cellular module 481, in response to receiving the alert data 705. Next at step 715, the modem 480 or cellular module 481 establishes a phone or cellular connection, in response to receiving the emergency phone number. Next at step 720 the microcontroller 435 sends the emergency message to the modem or cellular. The emergency message may be text information or audio information, usually the address of the unit the nature of the emergency, fire. Next at step 725 the modem or cellular module transmits the emergency message through the phone or cellular connection. After transmission of the emergency message 725, the microcontroller 435 will check the alert data for additional contact phone numbers at step 730. If there are additional contact phone numbers, the microcontroller 435 repeats the process by sending the additional phone number to the modem or cellular device 710. If there is not an additional phone number the microcontroller 435 terminates the routine at step 735.

FIG. 8 illustrates a flowchart of the mode and actuation programming 800 according to an embodiment of the present invention.

In operation, the mode and actuation limit programming 800, is completed on a computing device 491. First at step 810, the computing device 491 accesses the main operating program. Next at step 820, the computing device 491 is used to enter an active temperature value. The active temperature value is the temperature at which the microcontroller 435 shifts the system to active mode. Most homes temperatures are maintained at approximately 70-80 éF, so in the preferred embodiment the active temperature value is 90 éF or another temperature, high enough to ensure that the system is not wasting energy or wearing components by continuous targeting, but low enough to allow the system to begin targeting before the area reaches an actuation temperature. The active temperature value is set to a lower or higher value depending on the environment of the space to be protected, for example 85, 100, or 110 éF. Next at step 830, the computing device 491 is used to enter an actuation temperature value. Typical home sprinkler systems activate between 135-190 éF, so in the preferred embodiment the actuation temperature value is 140 éF, near the lower end of the band. The actuation temperature value is set to a higher or lower value depending on the environment of the space to be protected, for example 135, 150, or 190 éF. Next at step 840, the computing device 491 is used to enter an actuation temperature rate. Rate rise thermal detectors are typically set for actuation at 12éF over a minute, in the preferred embodiment the temperature rate value is an increase of 3.6 éF over 10 seconds. The actuation temperature rate value is set to a higher or lower value depending on the environment of the space to be protected for example 3, 4, or 5 éF over 10 seconds. The actuation temperature rate value can also be set to a shorter or longer time window, such as 3.6 éF over 5 seconds or 3.6 éF over 20 seconds.

In an embodiment of the invention, all values and criteria are set to defaults. The computing device 491 can be used to change any or all of the values and criteria as desired. In this embodiment, the computing device 491 is still required to enter the height of the system and to assign sensor designations and locations.

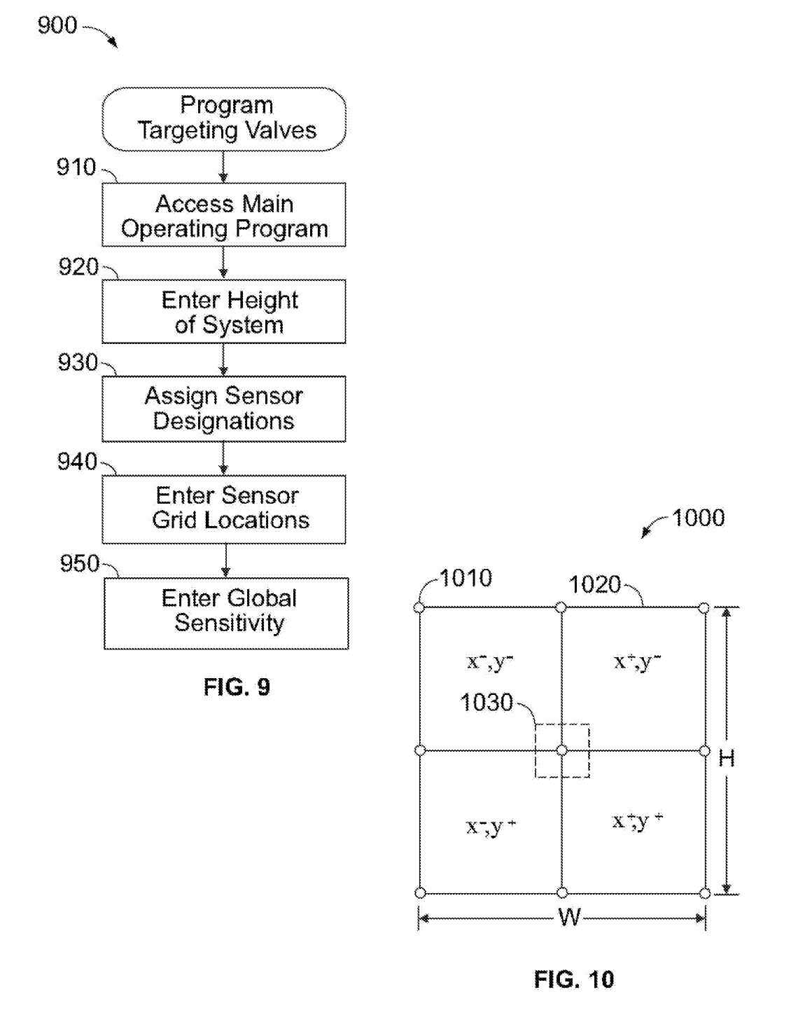

FIG. 9 illustrates a flowchart of programming targeting values 900 according to an embodiment of the present invention.

First at step 910, a computing device 491 is used to access the main operating program 910. Next at step 920, the computing device 491 is then used to enter the height of the system. The height of the system is determined by the physical position of the system in the room to be protected, for example 8 ft from the floor. Next at step 93C, the computing device 491 is used to assign sensor designations. Each sensor in the sensor grid 441 is assigned a designation, this provides the main operating program with the total number of detectors and the sensor's reference nomenclature. In the preferred embodiment the sensors are designated A0, A1, A20. Next at step 940, the computing device 491 is used to enter sensor grid locations. Each sensor in the sensor grid 441 is assigned a grid location in distance from the emitter 245 on an x/y axis. For example 9 sensors placed in an 8 ft×8 ft room may be placed in at the following positions, each value being the distance on the floor from the reference point of the emitter 245: 0,0 (directly below the emitter); −4,4; 0,−4; 4,−4; 4,0; 4,4; 0,4; −4,−4; and −4,0. Each position corresponds to the farthest corners of the room, the walls and the emitter reference in feet. Next at step 950, the computing device 491 is used to enter a global sensitivity. The global sensitivity is a multiplication constant applied to allow the program to use temperature data greater than 1 standard deviation from the Temperature Reference in the targeting angle calculation. Although referred to as a grid pattern, the sensors do not have to be laid out in a regular Cartesian grid but can be irregular or randomly laid out so long as their appropriate locations are programmed in.

FIG. 10 illustrates an overhead view of a sensor grid 1000 according to an embodiment of the present invention. The sensor grid includes a plurality of sensors 1010 a supporting structure 1020 and the extinguishing agent emission system 1030.

The sensors 1010, of the sensor grid 1000, are physically connected to the supporting structure 1020, and electrically connected to the extinguishing agent emission system 1030. The automatic fire targeting and extinguishing system 1030 is physically connected to the supporting structure 1020.

In operation, the supporting structure 1020 is a ceiling and support rafters or false ceiling anchor hanging attachments, for example, where the true ceiling is too high for effective discharge of the extinguishing agent. The automatic fire targeting and extinguishing system 1030 is preferably positioned near the center of the area to be protected by the unit. The sensors 1010 are placed in a grid pattern connected to the supporting structure. In the preferred embodiment the sensors 1010 are supported by the ceiling tiles, drywall, or wallboard. Alternatively, the sensors 1010 are suspended from the support structure 1020, where the true ceiling is too high for effective discharge of the extinguishing agent. As the heat from a fire rises, the sensors 1010 are most effective at the highest point of the room, but could be positioned at lower positions depending on the environment of the space to be protected. The sensors 1010 are electrically connected to the extinguishing agent emission system 1030.

The position of the emitter 245 from the floor is measured and entered as the height of the system 910 of the programming targeting values 900 as illustrated in FIG. 9. The position of each sensor 1010 is measured from the emitter reference position. For example, the sensor at center with the emitter is given a value of 0,0. The sensor 1010 in an 8 ft by 8 ft room in the right bottom corner is given a value of 4, 4 corresponding to 4 ft right (or + x axis), 4 ft. down or (+ y axis). The sensor 1010 at the right top of die room would be assigned a value of −4,−4, corresponding to 4 ft left (− x axis) and 4 ft. up or (− y axis). Each of the grid locations is entered as a sensor grid location 940, of programming targeting values 900.

In an alternative embodiment, the extinguishing agent emission system 1030 is positioned at a location other than the center of the room. This is desirable where other fixtures such as electrical lights are positioned in the center of the ceiling. The grid locations are determined by measuring the distance of each sensor 1010 form the emitter reference position.

In an alternative embodiment the area to be protected is larger than the effective discharge of the extinguishing agent emission system 1030, a plurality of extinguishing agent emission systems are installed. The sensor grid 1000 overlaps or has a common area by connecting the sensors 1010 to multiple units. For example, in a 16×8×8 room 2 extinguishing agent emission systems 1030 of the preferred embodiment are necessary. Each extinguishing agent emission system 1030 is electrically connected to 9 sensors 1010. The 3 sensors at the shared edge of coverage are electrically connected to both extinguishing agent emission system, therefore only 15 sensors are used. In an alternative embodiment, each extinguishing agent emission system 1030 has its own set of 3 sensors at the shared edge of coverage and 18 sensors are used.

FIG. 11 illustrates the calculation of targeting angles 1100 according to an embodiment of the present invention.

In operation, the microcontroller 435 runs the main operating loop. The microcontroller 435 determines the global sensitivity 1105 from the stored value from the programming target values 900 (FIG. 9).

Global Sensitivity Factor=μ=0.3 Equation 1

The microcontroller 435 then calculates the average temperature 1110 by using the individual sensor 1110 temperatures.

$$Average = \overline{T} = \frac{1}{n} {\sum }_{i = 1}^{n} {T}_{i} = \frac{{T}_{1} + {T}_{2} + … + {T}_{n - 1} + {T}_{n}}{n} \qquad Equation 2$$

The microcontroller 435 uses the average temperature to calculate the standard deviation 1110, from the average sensor temperature.

$$Std . Deviation = s = \sqrt{\frac{{\sum }_{i = 1}^{n} {( {T}_{i} - \overline{T} )}^{2}}{n - 1}} \qquad Equation 3$$

Following the calculation of standard deviation 1115, the microcontroller 435 calculates a reference temperature 1120 using the standard deviation, the global sensitivity value and the average temperature.

Reference=Ref=T̅+s*μ Equation 4

Following the calculation of the reference temperature 1120, the microcontroller 435 calculates a range 1110. The range is the highest temperature from the sensors 1110 minus the reference temperature. If the range is a value of less than 0.5 éF the microcontroller 435 sets the range value to 1.

Range(set to 1 if value less than 0.5)=Tₘₐₓ−Ref Equation 5

Following calculating the range 1122, the microcontroller 435 compares the individual sensor 1110 temperature to the reference temperature 1125. If the individual sensor 1110 temperature is less than the reference temperature the microcontroller 435 sets the sensor weight to zero 1130. If the individual sensor temp is greater than the reference temperature 1125, the micro controller calculates the sensor weight 1135. The microcontroller 435 calculates the sensor weight using the temperature detected by the sensor 1110 expressed TFI (Temperature Fahrenheit Individual), the reference temperature and the range.

$$PercentTempI = \frac{TFI - Ref}{Range} \\ ( only if TFI > Ref , otherwise = 0 ) \qquad Equation 6$$

Following the calculating sensor weight 1135 or the setting sensor weight to zero 1130, the microcontroller 435 calculates the fire location 1140. First the microcontroller 435 calculate an output position for each sensor on the x and y axis, using the sensor weight and the entered grid locations.

OutPosAX=PercentTempA*SensPosAX

OutPosAY=PercentTempA*SensPosAY Equation 7

Next, the microcontroller adds the sensor weighs to determine a Sum Percent Temperature value.

SumPercentTemp=PercentTempA+ . . . +PercentTempI Equation 8

The microcontroller 435 then adds the output position for each sensor to determine an x axis Sum output and a y axis sum output.

SumXout=OutPosAX+OutPosBX+ . . . +OutPosIX

SumYout=OutPosAY+OutPosBY+ . . . +OutPosIY Equation 9

The microcontroller 435 then calculates the elevated heat position or fire location on an x and y axis, using the sum x ax is or sum y ax is output and the sum percent temperature value.

$${X}_{fire} = \frac{SumXout}{SumPercentTemp} , \\ ( only if SumPercentTemp does not equal 0.0 ) \\ {Y}_{fire} = \frac{SumYout}{SumPercentTemp} , \\ ( only if SumPercentTemp does not equal 0.0 ) \qquad Equation 10$$

After the microcontroller 435 has calculated the elevated heat position 1140, the micro controller calculates targeting angle data 1145. The microcontroller calculates a targeting angle for both the x and y axis, using the elevated heat position 1140, and the entered height of the system 920, or ceiling height.

$$angle α = {tan}^{- 1} ( \frac{{X}_{fire}}{Ceiling Height} ) * \frac{180 deg}{π} \to \\ send to ServoAlpha \\ angle β = {tan}^{- 1} ( \frac{{Y}_{fire}}{Ceiling Height} ) * \frac{180 deg}{π} \to \\ send to ServoBeta \qquad Equation 11$$

In the current embodiment of the present invention, the principle method of locating the fire is based on an infra-red sensor. In this embodiment, the fire targeting and extinguishing system only starts to locate the fire based on the appropriate conditions from the other sensors. The mode of searching for the fire using the infra-red sensor is referred to active mode; and alternatively, the mode before the active mode starts is referred to as monitor mode. This embodiment of the invention is described in sections [00107] through [00145].

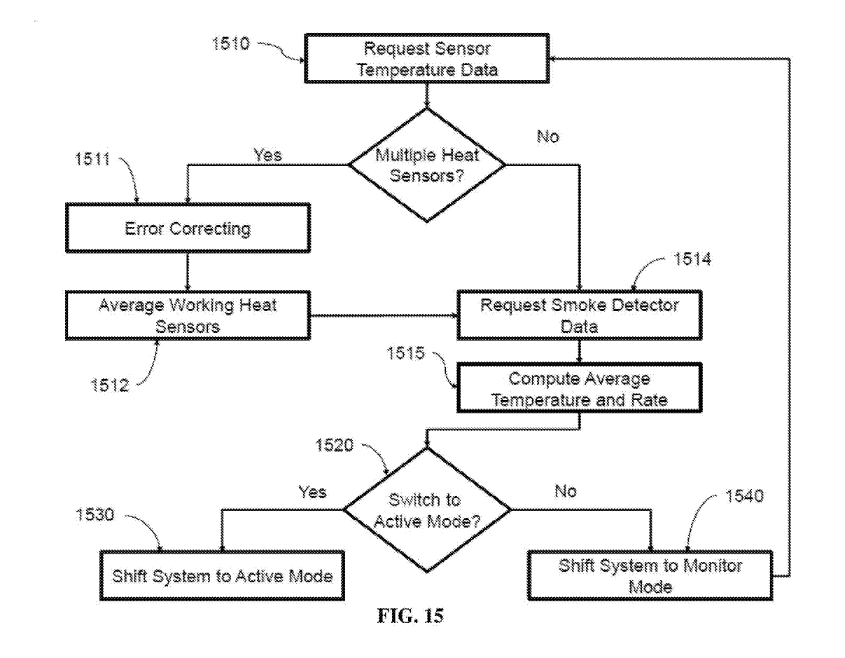

FIG. 15 illustrates a flow chart of the awakening criteria according to an embodiment of the present invention.

First in step 1510, the microcontroller 435 requests information from the heat sensor in sensor group 441. If there are multiple heat sensors such as multiple thermistors or thermocouples, the system does error correcting at step 1511 to determine which heat sensors are working. Next in step 1512, the working heat sensors are averaged together to give one value. The microcontroller 435 writes this temperature value to memory and deletes the oldest reading. The multiple and single heat sensors paths rejoin at step 1514, where the microcontroller requests data from the smoke detector. At step 1515, the microcontroller computes a linear least squares (often referred to as linear regression) fit to the past 20 temperature readings. Least squares is used to fit a temperature versus time equation to the data points. Evaluating this equation at the current time gives the average temperature and evaluating the time derivative of this equation at the last time gives the average rate of temperature increase. In the present embodiment, a linear equation is used to model the data points. In an alternative embodiment, a different type of equation such as but not limited to a quadratic, constant, or power law can be used. The averaging of the temperature data 515 prevents microcontroller actions based on electrical noise or random temperature fluctuations. The temperature data averaging range, over 20 readings in the preferred embodiment but is changed to a higher or lower valve, such as 10, 15, 30, or 50 readings depending on the detectors used and the environment to account for the relative noise detected by the sensors. Next at step 520, the microcontroller 435 determines if it should switch from monitor node to scanning mode. If the criteria are met, the system shifts to active mode as shown in step 1530; else the system remains in monitor mode and repeats this process as shown in 1540.

In the current embodiment three criteria are used to determine if the system should switch to active mode These are the average temperature, the average rate of temperature increase, and the presence of smoke. The microcontroller compares these values to predetermined limits. These predetermined limits are set high enough to prevent the system from entering active mode when no fire conditions exist. This prevents wear on the system components and conserves energy by preventing continuous targeting and hunting. In the current embodiment, the predetermined temperature value is 100 éF and the predetermined rate of temperature increase is 10 éF per second. In the current embodiment, no predetermined smoke level criteria is used as standard commercially available smoke detector with preset limits is used to determine if smoke is preset or not. This does not preclude the use of the microcontroller 435 from determining the level of smoke and having a predetermined limit. These predetermined values can be set to a higher or lower value to accommodate the environment of the space to be monitored, for example 85, 90, 110, or 200 éF for the average temperature and 0.5, 1, 5, 15, or 20 éF per second as examples for the average rate of temperature increase. In the current embodiment, if any of these three limits are exceeded, the microcontroller 435 shifts to active mode 1530. If none of these cases are met, the system stays in monitor mode 1540. This does not preclude the use of different logic using the same three inputs, averaged temperature, averaged rate of temperature increase, and presence of smoke, to determine if the system should switch to monitor mode. One example of such different logic is but is not limited to is requiring all three criteria to be met instead of only one. The system completes this check every program cycle. After the system shifts to active mode 1530 or shifts to monitor mode 1540 the microcontroller 435 will recommence the process by requesting sensor temperature data at step 1510.

In an alternative embodiment of the current invention, only the average temperature and average rate of temperature increase are used as criteria for switching from monitor mode to active mode. The presence of smoke is accounted for by modifying the predetermined temperature value and the predetermined rate of temperature increase. These predetermined values can be set based on the environment of the space to be monitored, for example 85, 90, 100, 110, or 200 éF for the average temperature and 0.5, 1, 5, 10, 15, or 20 éF per second as examples for the average rate of temperature increase. If the presence of smoke is detected, these predetermined values are reduced. In one embodiment, they are reduced by 10%, but could also be set to be reduced by 5% or 20% as examples. In another embodiment, the reduction is proportional to the amount of smoke detected.

If additional sensors are included in the system, such as carbon monoxide, carbon dioxide, ultraviolet detector, or others, the values from these sensors can be included in the monitor to active mode criteria as well.

The monitor mode to active mode shown in FIG. 15 and described above does not preclude the use on additional criteria being used to switch from monitor to scanning mode such as manual user input or input from a separate monitoring system such as an existing fire alarm system.

In the current embodiment, once the system shifts to active mode, it starts scanning the room with the infra-red sensor attached to the end of the emitter 345. When first switching to active mode, the system scans the entire room, taking infra-red images at appropriate locations so that the entire coverage area is photographed initially. First a search pattern of positioning angles that determines the locations to be viewed is calculated. This search pattern depends on the coverage area and the field of view of the sensor. Then the emitter 345 with the infra-red sensor attached is moved to each set of position angles. Based on the location of the emitter and the known location of each pixel in reference to the overall sensor position, the microcontroller calculates the position of each pixel in the current image. Based on the temperature and position associated with each pixel, the microcontroller calculates the position and temperature of a potential fire in the current image. The emitter than moves the infra-red sensor picture to the next location and repeats. Once the entire scan is completed, the system weights each local potential fire position and temperature and computes the global fire position and temperature.

In the current embodiment upon shifting to active mode, the infra-red sensor first scans the entire coverage area; this consists of the emitter 345 rotating the infra-red sensor to each of the preset locations and taking an infra-red image. In an alternative embodiment, this scan can stop before completion based on data from the current infra-red image.

In an alternative embodiment, every infra-red sensor in a scan is saved. After the scan is complete, an infra-red picture of the entire scan is assembled and the fire's location and temperature is computed from this assembled image.

In an alternative embodiment an infra-red sensor with afield of view that is at least is large as the cover area is used. In this embodiment, the infra-red sensor is not attached to the end of the emitter 345 and no moving or scanning with the infra-red sensor is required.

In the current embodiment, the position of the potential fire is calculated using a modified centroid approach. The microcontroller assigns each pixel a weight based on its temperature, with any pixel having a temperature below a reference temperature having a weight set to 0. The position of the potential fire is then the sum of the product of each pixel's weight and temperature divided by the sum of all the pixel's weights assuming that this sum is not zero. If this sum is zero, there is no potential fire in the infra-red image and the fire's position is set to the emitter's position (for purposes of not having uninitialized values in software only, this position will not be used to calculated the actual fire's position as it is assigned a 0 éF value.

In an alternative embodiment; each pixel is weighted not only based on the temperature, but on the current location of the pixel as well.

In the current embodiment, the potential fire's temperature within a single infra-red image is taken to be the average of the four hottest pixels in the infra-red image. In an alternative embodiment, this is changed to be the single hottest pixel, the average of the hottest 10 pixels, or other similar logic. In another alternative embodiment, the potential fire's position is taken to be the average of the four pixels surrounding the potential fire's location.

In the current embodiment, the potential fire's size within a single infra-red image is taken to sum of every pixel from the infra-red image greater than a preset limit. In the current embodiment, this limit is 400 lF, but this does not preclude a different value being used. In an alternative embodiment, the location of each pixel is factored into the calculation of the size of fire. In an embodiment that uses an IR sensor with a higher pixel count such as one that has a field of view large enough to view the entire area where the emitter can target, the sum is carried out over every pixel that is above the preset limit and that is adjacent (including diagonally adjacent) to the potential fires location.

In the current embodiment once the current scan is completed and the fire's location is calculated, the microcontroller executes a new scan focused on the area around the fire's position. This scan is the carried out in the same manner as before, but the area to be scanned is smaller and centered around the fire's location instead of covering the entire environment. The purpose of this secondary scan is to make sure that the microcontroller has current infra-red data about the potential fire. In an alternative embodiment, this secondary scan is unnecessary if the scanning speed is fast enough that even the oldest infra-red data in the global scan is current enough.

Once the system has located the fire it checks the time averaged temperature of the heat sensors in sensor group 441, time averaged rate of increase of the heat sensors, and the infra-red images taken centered at the fire. Based on these, the microcontroller either determines that there is a fire and commences the extinguishing routine or determines that it is not yet a fire and searches the environment again.

In the current embodiment, the system switches from active mode back to monitor mode if all of the sensors report values that are below the criteria needed to switch from monitor mode to active mode. This is accomplished by the microcontroller continuing to request temperature and smoke data and processing it according to FIG. 5.

In one embodiment, after a set time from switching to active mode from monitor mode without finding a fire, the system switches back to monitor mode.

Once the scanning mode has targeted the potential elevated heat position, the system determines if it should activate or not. In the current embodiment, six criteria are used to determine activation. These six criteria are: temperature recorded by the thermistors or heat sensors, rate of increase of temperature recorded by the thermistors or heat sensors; temperature of the elevated heat position recorded by the infra-red sensor, size of the elevated heat position recorded by the infra-red sensor, rate of growth of the temperature of the elevated heat position, and rate of growth of the size of the elevated heat position. In the current embodiment activation occurs if any one of these six criteria are met. However, this does not preclude the use of different logic, such as requiring that at least two of the six criteria are met. In an alternative embodiment, the presence of smoke is factored into the criteria. In one embodiment, this is accomplished by lowering the preset limits by a set amount or percentage if smoke is detected. In an alternative embodiment, this is accomplished by reducing the preset limits by amounts proportional to the amount of smoke detected.

If additional sensors are included in the system, such as sensors for detecting carbon monoxide, carbon dioxide, ultraviolet light or other phenomenon, the values from these sensors can be included in the activation criteria as well.

In the current embodiment, if the criteria are not met for activation, the fire extinguishing system continues to monitor the elevated heat position and the nearby area. This allows rate of growth of the size and temperature of the elevated heat position to be calculated and used in the activation criteria. If after a set time of monitoring the elevated heat position, the conditions for activating are not met, the system recommences a global scan.

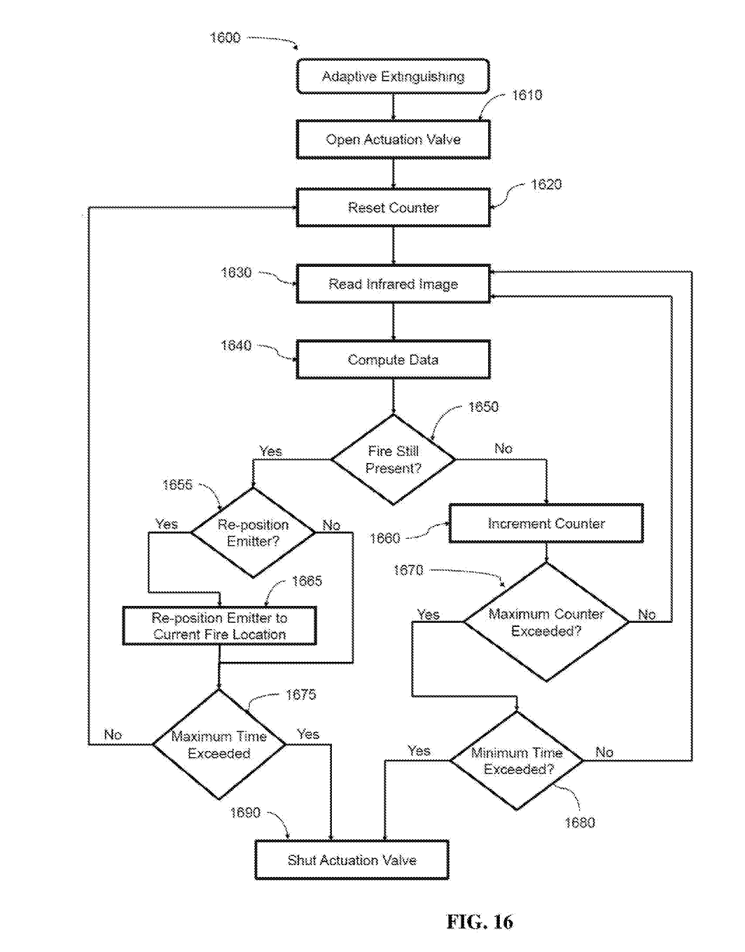

FIG. 16 shows the extinguishing routine according to the current embodiment of the preset invention.

Upon the fire being located and the activation criteria being met or exceeded, the microcontroller 435 sends the single to open the actuation valve as seen in step 1610. Next in step 1620, the microcontroller resets a counter. The counter is used later in the routine to determine how many infra-red images has passed with no fire present. In step 1630, a new infra-red image is read from the infra-red sensor which is centered at the fire's location. Based on each infra-red image, the control circuit 235 calculates the fire's location and representation of the fire's temperature as seen in step 1640. Next the microcontroller 435 determines if the fire is still preset as represented in step 1650. In the current embodiment, this is determined using the fire's temperature. If the fire's temperature is less than 100 éF, the fire is considered out. This does not preclude the use of value or different logic being used to determine if the fire is extinguished. If the fire is still present; the routine moves to step 1655. In step 1655; the microcontroller determines if it should reposition the emitter. In the current embodiment, this is determined using the fire's temperature. If the fire s temperature is greater man 400 éF, the microcontroller calculates a new set of targeting angles from the infra-red image and re-positions the emitter as seen in step 1665. This does not preclude the use of value or different logic being used to determine if the emitter should be moved. If the conditions are not met to re-position the emitter 345, the emitter 345 remains in the same location.

In one embodiment, the microcontroller 435 is programmed with a dead zone to prevent continuous targeting and hunting. In this embodiment, the emitter is only moved while emitting extinguishing agent if both targeting angles change by greater or equal to 2%. This dead zone value of 2% is not specific and does not preclude a different value being used. This is not shown in FIG. 16 but would occur as part of step 1665.

In the present embodiment, a maximum suppressant discharge time is built in as shown in step 1675 where the actuation circuit 232 sends the shut signal to the actuation valve 231 after a set time after the actuation circuit 232 sent the open signal to the actuation valve 231. This maximum discharge time can be set to infinity; i.e. the maximum discharge time is not used. In an alternative embodiment no maximum discharge time is utilized. If the maximum discharge time is not exceeded, the routine moves back to step 1620 and repeats.

At step 1650, if no fire was present, the microcontroller executes steps 1660 and increments the counter. This counter keeps track of how many infra-red frames are recorded in a row with no fire present. At step 1670, if no fire is preset for a set number of consecutive infra-red images, the microcontroller closes the actuation valve. In the present embodiment this is set to 10 images but this does not preclude a different value from being used. If the set number of consecutive infra-red images without a fire present is not reached, the microcontroller executes step 1630 and reads a new infra-red image.

In the present embodiment, a minimum suppressant discharge time is built into ensure that the actuation circuit 232 has to wait a minimum amount of time, 4 seconds in the present embodiment before it can send the shut signal to the actuation valve 231. This is seen in step 1680. This minimum discharge time can be set to 0; resulting in no minimum discharge time. The minimum discharge time can also be set to infinity, resulting in all the suppressant being released.

In operation, the mode and actuation limit programming 800, is completed on a computing device 491. First at step 810, the computing device 491 accesses the main operating program. Next at step 820, the desired values and criteria can be set. These all come with default values and only need to be changed if desired. The values and criteria than can be set include but is not limited to:
Awakening average temperature value can be set to infinity, i.e. not used
Awakening average rate of temperature increase can be set to infinity, i.e. not used
Actuation average temperature value can be set to infinity, i.e. not used
Actuation average rate of temperature increase can be set to infinity, i.e. not used
Actuation fire size can be set to infinity, i.e. not used
Actuation fire temperature can be set to infinity, i.e. not used
Actuation growth in fire size can be set to infinity, i.e. not used
Actuation growth in fire temperature can be set to infinity, i.e. not used
Minimum discharge time can be set to 0, i.e. not used, or set to infinity, i.e. discharges all suppressant
Maximum discharge time can be set to infinity, i.e. not used

In the current embodiment all values and criteria are set to defaults and thus special programming is not required but programming can be used to change any or all of the values and criteria as desired.

In the current embodiment, every sensor is physically connected to the automatic fire targeting and extinguishing system 1030 so no method is necessary to compute sensor positions. This reduces installation time and reduces the risk of improper installation. Every sensor is also electrically connected to the extinguishing agent emission system 1030. The automatic fire targeting and extinguishing system 1030 is physically connected to the supporting structure 1020.

In the current embodiment, the targeting angles are calculated directly without needing the height of the system, no method is necessary to compute the height of the system. This is accomplished by computing the targeting angles based on the infra-red sensor 1435 mounted to on the emitter 345. For each infra-red image taken, the position of the emitter 345 is known; and the location of each of the pixels in the infra-red sensor is calculated based on the angle of the emitter. The targeting angles for the elevated heat position, being computed based of one or more infra-red images, is thus independent of the height of the system and is also independent of the orientation of the system.

In operation, the supporting structure 1020 is a ceiling and support rafters or false ceiling anchor hanging attachments, for example, where the true ceiling is too high for effective discharge of the extinguishing agent. The automatic fire targeting and extinguishing system 1030 is preferably positioned as near the center of the area to be protected by the unit. However, the calculation of targeting angles and position the emitter towards the elevated heat position is independent of the orientation of the system and hence the system could be mounted from the walls, set freestanding in the environment or the like.

In an alternative embodiment, the system includes a modem 480 or cellular module 481, a data port 482, and a memory unit 483. The microcontroller is in data connection with the modem 480 or cellular module 481, the memory unit 483, and the data port 482. The modem is in data communication with a phone line. A computing device is connected to the data port 482.

In operation, the computing device sends alert data to the micro controller 435. The microcontroller 435 stores the alert information in the memory unit 483. The alert data can include a phone number or email address and emergency message including the address or location of the system. The emergency message may be either text, voice, or other announcement or notification. The phone number may be a public or private emergency number. When the microcontroller 435 sends the activation signal to the actuation valve 431, the microcontroller retrieves the alert data from the memory unit 483. The microcontroller sends the phone number portion of the alert data to the modem 480 or cellular module 481. When the modem 480 or cellular module 481 establishes a connection with a receiver through the phone line, the modem sends a communication established signal to the microcontroller 435. In response to the communication established signal, the microcontroller 435 sends the emergency message to the modem 480 or cellular module 481. The modem 480 or cellular module 481 transmits the emergency message to the receiver through the phone line to the receiving party. If the alert data includes multiple numbers, such as emergency service and owner, the microcontroller will execute the alert transmissions in the order that the numbers are programmed, until all emergency messages have been delivered.

FIG. 13 illustrates an assembled view of a targeting gimbal 1300. The targeting gimbal 1300 is the same as the targeting gimbal 300 of FIG. 3, but assembled for context.

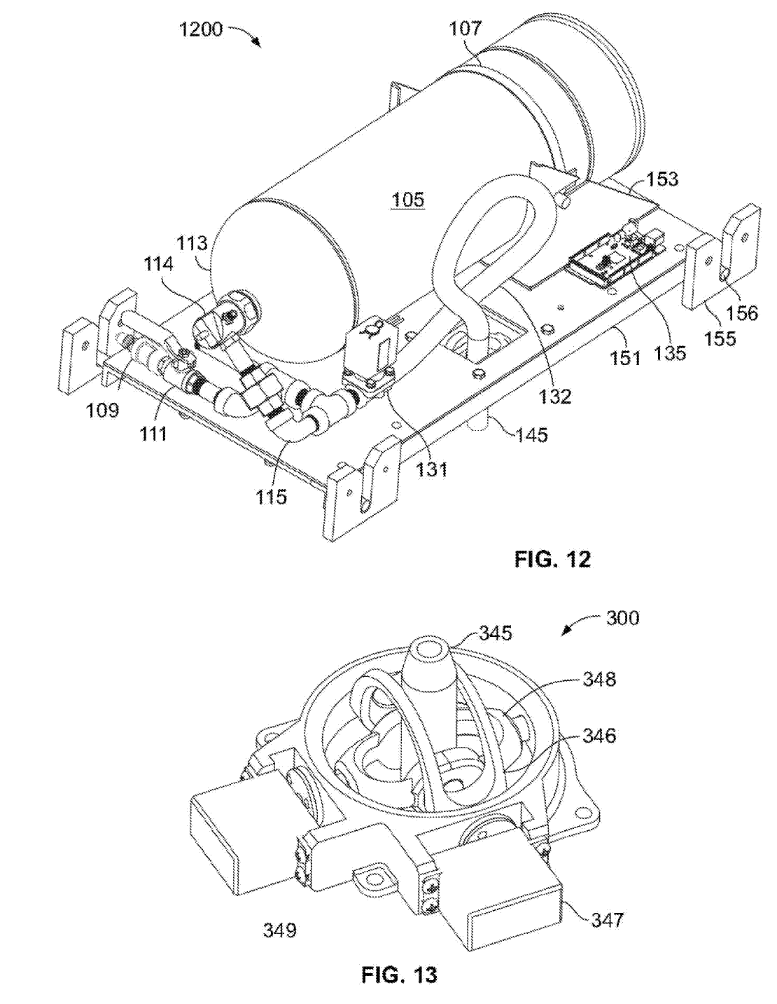

FIG. 12 illustrates an assembled view of an extinguishing agent emission system 1200. The extinguishing agent emission system 1200 is the same as extinguishing agent emission system 100 of FIG. 1, but assembled for context.

In one embodiment of the system a user can remotely monitor and take control of the system. A graphical user interface or other interface such through a terminal can be used to view in real or near real time all current sensor data from the system. Through this interface, a user can control the location of the emitter 345 and direct it to any desired location. The user can also open or close the actuation valve to control the flow of suppressant.

In one embodiment of the current invention, multiple fire targeting and extinguishing system as taught herein can be networked together, through either a wireless or wired network. When a fire targeting and extinguishing system commences extinguishing a fire, it transmits this fact and the location of the fire to the other fire targeting and extinguishing devices. Each fire targeting and extinguishing system is pre-programmed with the locations of the other fire targeting and extinguishing systems. Once one fire targeting and extinguishing system commences extinguishing a fire, its neighboring fire targeting and extinguishing systems are set to a higher alert level until the fire targeting and extinguishing system that is extinguishing the fire declares the fire is completely extinguished. If the neighboring fire targeting and extinguishing systems also locate the fire, they shall commence extinguishing as well.

In one embodiment, this higher alert level consists of reducing the predetermined values for switching from monitor to active mode. This will allow the neighboring fire targeting and extinguishing systems to respond faster should the fire spread. In an alternative embodiment, this higher alert level consists of the neighboring fire targeting and extinguishing systems commencing scanning with their infra-red sensors over the area closest to the fire targeting and extinguishing system that is extinguishing a fire.

In some embodiments of the prior art the extinguishing device required a user to be in close proximity with the fire to effectively discharge the extinguishing agent. The automatic fire targeting and extinguishing system is redundantly automatic. In normal operation the system locates, targets, and Discharges extinguishing agent onto the fire. In backup mode the system utilizes a sprinkler head to discharge the extinguishing agent onto the area. Both modes operate automatically without a user, maximizing the safety of personnel.

In some embodiments of the prior art the extinguishing system discharged nearly unlimited amounts of extinguishing agent causing unnecessary damage to unaffected areas and flooding. These systems further failed to utilize a targeting system. To ensure that a fire was effectively extinguished the system relies on continually discharging until a user shuts off the supply. The automatic fire targeting and extinguishing system of the present inventions requires only a limited capacity and has a targeting system. The utilization of the targeting system allows the automatic fire targeting and extinguishing system to discharge a small amount of extinguishing agent directly at the fire. This minimizes the damage to unaffected areas and limits the amount of extinguishing agent required to effectively extinguish the fire.

In some embodiments of the prior art the extinguishing system used clean agents to displace the oxygen to smother the fire. The use of clean agents prevents damage to valuable equipment and unaffected areas, but endangers any personnel that are present either during or after the discharge. The automatic fire targeting and extinguishing system of the present invention does not require the use of clean agents to maximize the effect extinguishing of the fire while minimizing the damage to property. Therefore, it does not have inherent risk to personnel.

In some embodiments of the prior art the extinguishing system was configured for infra-red detection only, limiting the possible applications and targeting inputs. The automatic fire targeting and extinguishing system of the present invention is configured to use temperature detectors, infra-red sensors, ion chambers, and thermal imaging to maximize the effectiveness of the targeting system and extinguishing routines.

In some embodiments of the prior art the extinguishing system utilized a targeting system with complex motor and gear combinations to position discharge emitters and armatures. The automatic targeting system of the present invention uses a simple gimbal targeting system with servos directly mounted to the armatures. This reduces the moving components of the targeting system and increases reliability. Further, the direct attachment of the servo to the armatures and armatures to emitter reduces travel distances, reducing the time necessary to position the emitter for discharge.

In some embodiments of the prior art used a single sensor for determining a fire location. This unnecessarily limits the coverage area and accuracy. The automatic fire targeting and extinguishing system of the present invention employs a plurality of sensor including an infra-red sensor(s) that can be moved to view any area in the coverage area. The use of multiple sensors and the movable infra-red sensor(s) maximizes the coverage area of the area to be protected and increases the placement accuracy of the extinguishing agent, because the system will have more and more accurate targeting information.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the sprit and scope of the invention.

What we claim is:

1. A fire-targeting and extinguishing apparatus including a directional sensor system, wherein the directional sensor system includes a plurality of sensors configured in a grid pattern; wherein a weighted average of the sensors' temperatures is used to determine an elevated heat position; and an extinguishing agent emission system which receives the elevated heat position and positions an extinguishing agent emitter to emit extinguishing agent toward the elevated heat position.

2. The fire targeting and extinguishing apparatus of claim 1, wherein the extinguishing agent emission system further includes an actuation valve; wherein the actuation valve opens to emit extinguishing agent in response to one or more temperature sensors detecting a temperature above a predetermined temperature value; and wherein the predetermined temperature can be influenced by the level of smoke detected by the fire targeting and extinguishing system.

3. The fire targeting and extinguishing apparatus of claim 2, wherein the actuation valve opens to emit extinguishing agent in response to one or more temperature sensors detecting a temperature rise rate above a predetermined temperature rise rate value wherein the predetermined temperature rise rate can be influenced by the level of smoke detected by the direction sensor system.

4. The fire targeting and extinguishing apparatus of claim 3 further including one or more infra-red sensors, wherein the actuation valve opens to emit extinguishing agent in response to the infra-red sensor detecting an elevated temperature location above a predetermined temperature wherein the predetermined temperature value can be influenced by the level of smoke detected by the fire targeting and extinguishing apparatus.

5. The fire targeting and extinguishing apparatus of claim 4, wherein the actuation valve opens to emit extinguishing agent in response to the infra-red sensor detecting an elevated temperature location above a predetermined size wherein the predetermined size value can be influenced by the level of smoke detected by the fire targeting and extinguishing apparatus.

6. The fire targeting and extinguishing apparatus of claim 5, wherein the actuation valve opens to emit extinguishing agent in response to the infra-red sensor detecting a rise in the temperature and/or growth in the size of an elevated heat location above a predetermined rise in temperature or growth in size wherein these predetermined rises can be influenced by the level of smoke detected by the fire targeting and extinguishing system.

7. The fire targeting and extinguishing apparatus of claim 6, wherein the actuation valve opens to emit extinguishing agent in response to an outside input including manually or remotely from a fire alarm system.

8. The fire extinguishing apparatus of claim 7, wherein the actuation valve shuts in response to the microcontroller reading the appropriate conditions from any or all of the sensors chosen from the following group: thermistors, thermocouples, digital heat sensors, infra-red sensor or camera smoke detector or upon a maximum extinguishing time being reached or based on outside input.

9. The fire targeting and extinguishing apparatus of claim 8, wherein the fire extinguishing agent is chosen from a group comprising of water, carbon dioxide, aqueous film forming foam, monoammonium phosphate, Purple-K, standard Class A/B/C dry chemical agent, and standard Class B/C dry powder chemical.

10. The fire targeting and extinguishing apparatus of claim 9, wherein the extinguishing agent is continuously pressurized.

11. The fire targeting and extinguishing apparatus of claim 10 wherein the directional temperature sensor system includes an infra-red sensor that can be moved to take images of any location in the desired coverage area; so as to determine an elevated heat position; and an extinguishing agent emission system, which receives the elevated heat position and positions an extinguishing agent emitter to emit extinguishing agent toward the elevated heat position.

12. The fire targeting and extinguishing apparatus of claim 11, wherein the system's ability to detect an elevated heat position and to position the extinguishing agent emitter toward the elevated heat position is independent of the system's orientation.

13. The fire targeting and extinguishing apparatus of claim 12, wherein the infra-red sensor seaming does not commence until the appropriate condition is detected.

14. The fire targeting and extinguishing apparatus of claim 13, wherein the condition to commencing scanning includes one or more of the following: temperature levels, rate of temperature level increase, presence of smoke, user input, or input from an outside system.

15. The fire targeting and extinguishing apparatus of claim 14, wherein while extinguishing the fire, the position of the emitter is continuously or repeatedly updated by the microprocessor where the updated position comes from the microprocessor continuously reading infra-red data from the infra-red sensor while extinguishing the fire and the microprocessor computing an updated elevated heat position from these readings.

16. The fire targeting and extinguishing apparatus of claim 15, wherein the sensor data can be repeatedly sent to an outside monitoring system.

17. The fire targeting and extinguishing apparatus of claim 16, wherein the outside monitoring system can control the fire targeting and extinguishing apparatus including positioning the emitter and opening and closing the actuation valve.

18. The fire targeting and extinguishing apparatus of claim 17, wherein multiple fire targeting and extinguishing apparatuses can communicate with each other when extinguishing a fire so that the fire targeting and extinguishing apparatuses adjacent to the fire targeting and extinguishing apparatus that is extinguishing a fire can more quickly respond should the fire spread into their associated coverage areas.

19. A method of targeting and extinguishing a fire comprising the steps of: continuously monitoring the environment for signs of potentials fires; once a potential fire is detected, locating any elevated heat position using an infra-red sensor; positioning an extinguishing agent emitter to the location of the elevated heat position; determining if the elevated heat position is a fire; and causing the extinguishing agent emitter to emit an extinguishing agent toward the position of the fire.

20. The method of targeting and extinguishing a fire of claim 19, wherein the infra-red sensor is moved to view every area that can be reached by the extinguishing agent emitter upon detecting a potential fire.
